(19) United States
(12) Patent Application Publication
(10) Pub. No.: US 2011/0072351 A1
(43) Pub. Date: Mar. 24, 2011

(54) INFORMATION PROCESSING DEVICE, INFORMATION PROCESSING METHOD, INFORMATION PROCESSING PROGRAM, AND COMPUTER-READABLE STORGAE MEDIUM HAVING INFORMATION PROCESSING PROGRAM STORED THEREON

(75) Inventors: Atsushi Shintani, Osaka (JP); Yoshinori Nagai, Osaka (JP); Yasunori Yamashita, Osaka (JP); Tatsuo Sudoh, Osaka (JP); Tomoyuki Kawasoe, Osaka (JP); Isao Kawachi, Osaka (JP)

(73) Assignee: SHARP KABUSHIKI KAISHA, Osaka-Shi, Osaka (JP)

(21) Appl. No.: 12/992,865

(22) PCT Filed: May 15, 2009
(86) PCT No.: PCT/JP2009/059092

§ 371 Date: Nov. 15, 2010

(30) Foreign Application Priority Data
May 16, 2008 (JP) 2008-130039

(51) Int. Cl. G06F 3/048

(52) U.S. Cl. 715/730

(57) ABSTRACT

An image display device (100A) includes: an icon display section (131) displaying a list of folder icons indicative of the folders, in an icon display area; and a preview slide show executing section (133) displaying a slide show of files stored in a folder, in a preview display area in a screen where the icon display area is present, the folder corresponding to a folder icon selected from among the folder icons displayed by the icon display means (131) in the list in the icon display area. This allows a user to easily make an operation for browsing a file or the like, concurrently with viewing a large preview screen.

### TECHNICAL FIELD

The present invention relates to an information processing device, an information processing method, an information processing program and a computer-readable storage medium having the information processing program stored thereon, each of which is for managing files stored in a folder.

### BACKGROUND ART

In recent years, it has become possible to retain a large amount of images including, for example, an image captured by a digital camera or the like, an image attached to an e-mail, and an image distributed on the Internet. Such images are deployed and present in various places. Further, such images are often hierarchized in folders or the like and then managed. Furthermore, such images may often be placed in a device separate from a device for displaying such images.

Therefore, it is required to display these images so that a user can easily view the images. That is, it is required to allow a user to quickly know images placed in each of a plurality of folders. In such a case, it is desirable that each of these images has a predetermined size or a size larger than the predetermined size in display so that a user can easily view the images. In addition, it is desirable that images placed in a device separate from a display device can also be displayed.

FIGS. 49 to 51 shows an example where reduced images are used, as a typical example of a case where images are displayed on a PC (personal computer). FIG. 49 is a diagram illustrating a hierarchical structure of folders and images assumed in this example.

Directly under a top layer (denoted as “(root)” in FIG. 49), folders 1 to 8, images A to F and a folder 9 are placed. Further, directly under the folder 1, images 1A and 1B, a folder 11, images 1C and 1D and a folder 12 are placed. Furthermore, directly under the folder 8, folders 81 and 82 are placed.

As shown in FIG. 50, a folder configuration on the PC is displayed in the form of icons of respective folders and thumbnails of respective files (image files). Here, if a mouse is clicked while a cursor is positioned on an icon of the folder 1, icons of respective folders and thumbnails of respective images which folders and images are placed directly under the folder 1 are displayed as shown in FIG. 51. Each of the thumbnails of respective images is a reduced image generated by reducing an original image. This makes it possible to check images that are placed in the folder 1.

Immediately after the above-described operation, an operation to return to the top layer is made in a case where images placed in the folder 2 are to be checked. Then, a display returns to a display of a screen shown in FIG. 50. Then, this time, it is necessary to click the mouse while the cursor is positioned on an icon of the folder 2.

Next, with reference to FIGS. 51 to 53, an example in which a slide show is performed is explained as another typical example of a case where images are displayed on a PC.

While content of a target folder (the folder 1) is displayed as shown in FIG. 51, an operation is made so as to give an instruction to start a slide show. Then, an initial image is displayed, as shown in FIG. 52, for a predetermined period, which is followed by display of a next image as shown in FIG. 53 for a predetermined period. In this way, all images in the folder 1, i.e., the images 1A to 1D are sequentially displayed. To automatically display images in sequence is referred to as “to perform a slide show”. When display up to the image 1D has been completed, the slide show is ended and a display returns to the display of FIG. 51. Alternatively, the display returns to the image 1A and the images are repeatedly displayed until an operation is made to give an instruction to stop the slide show. According to Patent Document 1, a plurality of icons indicative of folders are displayed, and a slide show of images in a folder which is selected from among the folders are displayed. The slide show here is displayed so as to be superposed on an image of the selected folder.

For a case where images and image folders are placed in a device separate from a display device, there is a well known method of displaying and browsing images placed in a DMS (Digital Media Server). According to the method, the images are displayed and browsed on a DMP (Digital Media Player) by using the DMS and the DMP according to home network standards of DLNA (Digital Living Network Alliance) (Registered Trademark) guidelines, or the like.

However, according to a conventional image display method using reduced images, a display size of each image becomes small because many images are concurrently displayed. On the other hand, if a window size is adjusted so that the display size of each image becomes larger, more scrolling by use of a scroll bar becomes necessary and, as a result, an operation becomes complicated.

Further, according to an image display method using a slide show, it is necessary to select an image folder which contains images that a user wants to view, every time before a slide show is carried out. Therefore, images in various folders cannot be displayed quickly.

Furthermore, according to the method disclosed in Patent Literature 1, by carrying out a slide show, the images in the folder can be sequentially browsed. However, because the slide show is performed in a display area of the folder, a display size of each image is small and the images are hard to view.

The present invention is attained in view of the above problems. An object of the present invention is to realize an information processing device, an information processing method, an information processing program, and a computer-readable storage medium storing the information processing program, each of which makes it possible to display, at a sufficient image size and at a sufficient resolution, a preview of files of images or the like stored in a folder.

### Citation List

[Patent Literature]

[Patent Literature 1]

Japanese Patent Application Publication, Tokukai, No. 2006-215966 (published on Aug. 17, 2006)

### SUMMARY OF INVENTION

In order to solve the above-mentioned problem, an information processing device of the present invention managing files stored in folders, the information processing device is configured to include: icon display means displaying a list of folder icons indicative of the folders, in an icon display area; and preview slide show executing means displaying a slide show of files stored in a folder, in a preview display area in a screen where the icon display area is present, the folder corresponding to a folder icon selected from among the folder icons displayed by the icon display means in the list in the icon display area.

Moreover, an information processing device, according to the present invention, of an information processing device managing files stored in folders, the method is configured to include the steps of: displaying a list of folder icons indicative of the folders, in an icon display area; and displaying a slide show of files stored in a folder, in a preview display area within a screen where the icon display area is present, the folder corresponding to a folder icon selected from among the folder icons displayed by the icon display means in the list in the icon display area.

According to the above configuration, it is possible to display a slide show of files stored in a folder corresponding to a folder icon selected from a list of folder icons which list is displayed. The slide show is displayed separately from the list of folder icons, but both the slide show and the list of folder icons are displayed in one screen.

Therefore, it becomes possible to display a preview of a plurality of files in a folder at a larger image size and at a higher resolution as compared to a folder icon. This allows a user to make an operation on a folder icon list display, concurrently with checking a preview image in which each file is easily viewed.

For a fuller understanding of the nature and advantages of the invention, reference should be made to the ensuing detailed description taken in conjunction with the accompanying drawings.

### BRIEF DESCRIPTION OF DRAWINGS

FIG. 1 is a functional block diagram illustrating a configuration of an image display device according to an embodiment of the present invention.

FIG. 2 is a block diagram illustrating a hardware configuration of the image display device shown in FIG. 1.

FIG. 3 is an explanatory diagram illustrating a remote controller for operating the image display device shown in FIG. 1.

FIG. 4 is a flowchart illustrating an operation of the image display device shown in FIG. 1.

FIG. 5 is an explanatory diagram illustrating an exemplary display screen of the image display device shown in FIG. 1.

FIG. 6 is an explanatory diagram illustrating an exemplary display screen of the image display device shown in FIG. 1.

FIG. 7 is a configuration diagram illustrating a configuration of a network system including an image display device according to another embodiment of the present invention.

FIG. 8 is a functional block diagram illustrating a configuration of an image display device according to another embodiment of the present invention.

FIG. 9 is a block diagram illustrating a hardware configuration of the image display device shown in FIG. 8.

FIG. 10 is an explanatory diagram illustrating an exemplary display screen of the image display device shown in FIG. 8.

FIG. 11 is a flowchart illustrating an operation of the image display device shown in FIG. 8.

FIG. 12 is a flowchart of process for starting a preview slide show in the image display device shown in FIG. 8.

FIG. 13 is an explanatory diagram illustrating an exemplary display screen of the image display device shown in FIG. 8.

FIG. 14 is a flowchart of a process of a preview slide show execution thread in the image display device shown in FIG. 8.

FIG. 15 is an explanatory diagram illustrating an exemplary content information list used in the image display device shown in FIG. 8.

FIG. 16 is an explanatory diagram illustrating an exemplary content information list used in the image display device shown in FIG. 8.

FIG. 17 is an explanatory diagram illustrating an exemplary content information list used in the image display device shown in FIG. 8.

FIG. 18 is an example of a detailed description of one image (image resource) in a content information list used in the image display device shown in FIG. 8.

FIG. 19 is an explanatory diagram illustrating an exemplary display screen of the image display device shown in FIG. 8.

FIG. 20 is a flowchart of an image display execution process on the image display device shown in FIG. 8.

FIG. 21 is an explanatory diagram illustrating an exemplary display screen of the image display device shown in FIG. 8.

FIG. 22 is a sequence diagram briefly illustrating exchange of information and data between an image server and the image display device shown in FIG. 8.

FIG. 23 is an explanatory diagram illustrating in detail transmission data that is used when the image display device shown in FIG. 8 “searches for a device (SSDP)”.

FIG. 24 is an explanatory diagram illustrating in detail transmission data that is used when “an image server makes a response and notifies the presence of the image server itself in the response” to the image display device shown in FIG. 8.

FIG. 25 is a sequence diagram briefly illustrating exchange of data and information between an image server and the image display device shown in FIG. 8.

FIG. 26 is an explanatory diagram illustrating in detail transmission data that is used in “notifying the presence of a device and a URL of a device description (SSDP)” to the image display device shown in FIG. 8.

FIG. 27 is a flowchart of a process for displaying an image server list in the image display device shown in FIG. 8.

FIG. 28 is a flowchart of an image server table generation thread in the image display device shown in FIG. 8.

FIG. 29 is an exemplary diagram illustrating a specific example of an image server table generated by an image server table generation thread in the image display device shown in FIG. 8.

FIG. 30 is an explanatory diagram illustrating a specific example of an image server list displayed by the image display device shown in FIG. 8.

FIG. 31 is a functional block diagram briefly illustrating a configuration of an image display device according to still another embodiment of the present invention.

FIG. 32 is a flowchart illustrating an operation of the image display device shown in FIG. 31.

FIG. 33 is a flowchart of a process for starting display of a large screen slide show on the image display device shown in FIG. 31.

FIG. 34 is a flowchart of a large screen slide show execution thread in the image display device shown in FIG. 31.

FIG. 35 is an explanatory diagram illustrating a specific example of content list information that is used in the image display device shown in FIG. 31.

FIG. 36 is an explanatory diagram illustrating an exemplary display screen of the image display device shown in FIG. 31.

FIG. 37 is an explanatory diagram illustrating an exemplary display screen of the image display device shown in FIG. 31.

FIG. 38 is an explanatory diagram illustrating an exemplary display screen of the image display device shown in FIG. 31.

FIG. 39 is a functional block diagram briefly illustrating a configuration of an image display device according to yet another embodiment of the present invention.

FIG. 40 is an explanatory diagram illustrating an exemplary display screen of the image display device shown in FIG. 39.

FIG. 41 is an explanatory diagram illustrating an exemplary display screen of the image display device shown in FIG. 39.

FIG. 42 is an explanatory diagram illustrating an exemplary display screen of the image display device shown in FIG. 39.

FIG. 43 is an explanatory diagram illustrating an exemplary display screen of the image display device shown in FIG. 39.

FIG. 44 is an explanatory diagram illustrating an exemplary display screen of the image display device shown in FIG. 39.

FIG. 45 is a sequence diagram briefly illustrating exchange of information and data between an image server and an image printer in printing for the image display device shown in FIG. 39.

FIG. 46 is a flowchart of a process for displaying an image printer list in the image display device shown in FIG. 39.

FIG. 47 is a flowchart of an image printer table generation thread in the image display device shown in FIG. 39.

FIG. 48 is an explanatory diagram illustrating a specific example of an image printer table generated by an image printer table generation thread in the image display device shown in FIG. 39.

FIG. 49 is an explanatory diagram illustrating an example of a hierarchical structure of folders and images.

FIG. 50 is an explanatory diagram illustrating an example in which a list of folder icons and image thumbnails are displayed, according to a conventional technique.

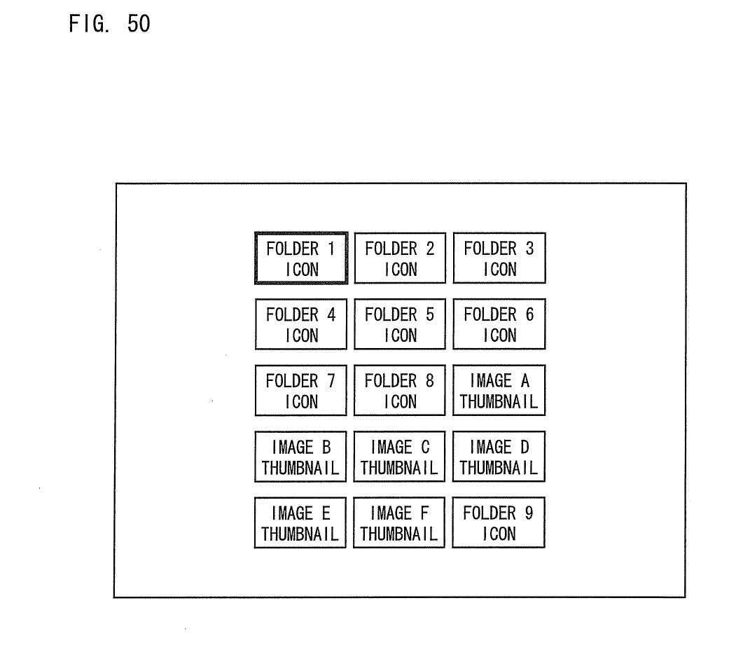

FIG. 51 is an explanatory diagram illustrating an example in which a list of folder icons and image thumbnails are displayed, according to a conventional technique.

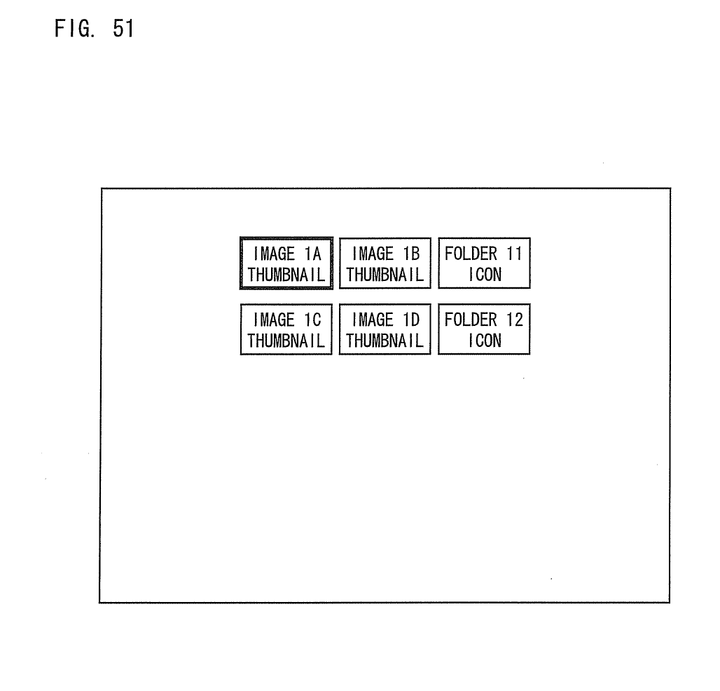

FIG. 52 is an explanatory diagram illustrating an example of a slide show according to a conventional technique.

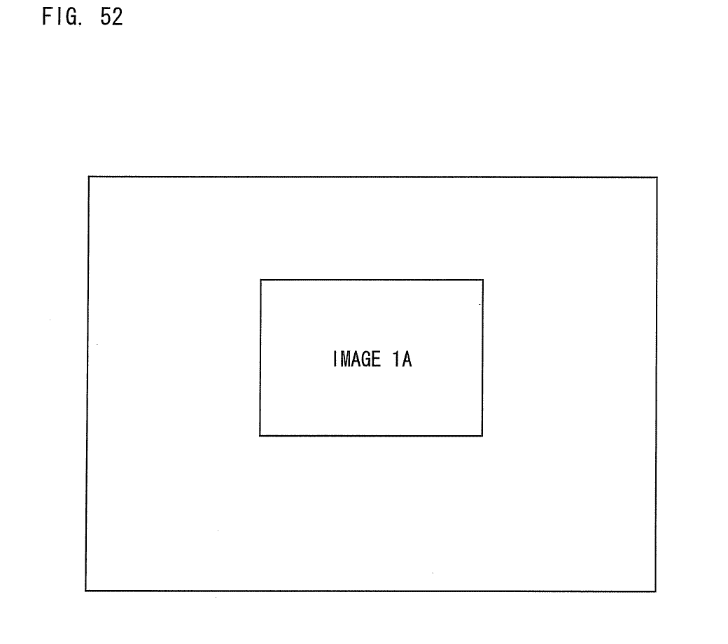

FIG. 53 is an explanatory diagram illustrating an example of a slide show according to a conventional technique.

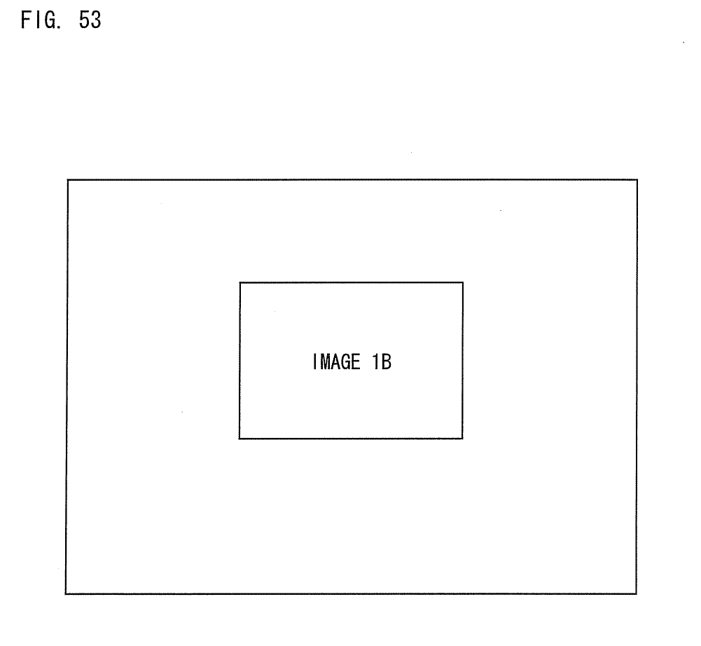

### DESCRIPTION OF EMBODIMENTS

The following embodiments explain examples in each of which the present invention is applied to an image display device for displaying digital static image files. However, the present invention is not limited to this. The present invention can also be applied to files other than such image files, for example, text files, moving image files, sound files or the like. Further, in the case of image files, an image thumbnail that is a reduced image of an image can be used as a file icon. Moreover, in the case of text files, a reduce image of a printed state of the first page can be used as a file icon. Furthermore, in the case of moving image files or sound files, a reduced image presenting a title can be used as a file icon.

### Embodiment 1

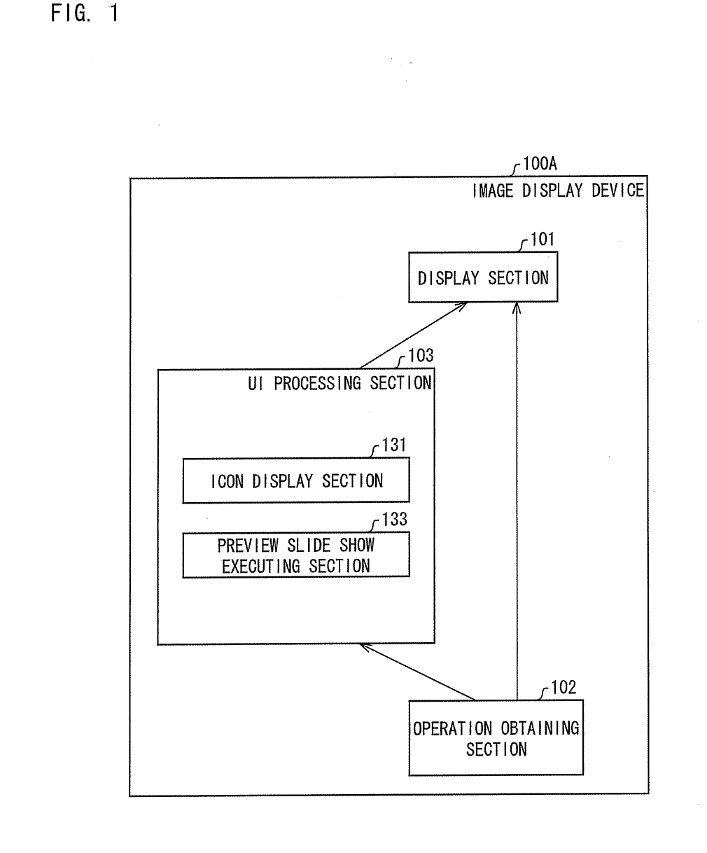

The following explains one embodiment of the present invention, with reference to FIGS. 1 to 6.

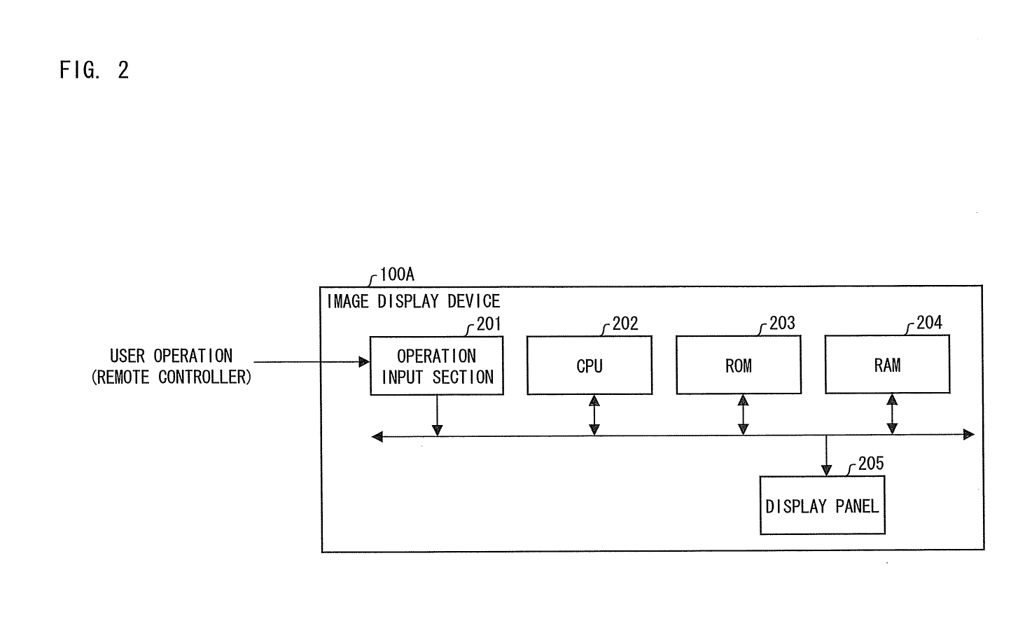

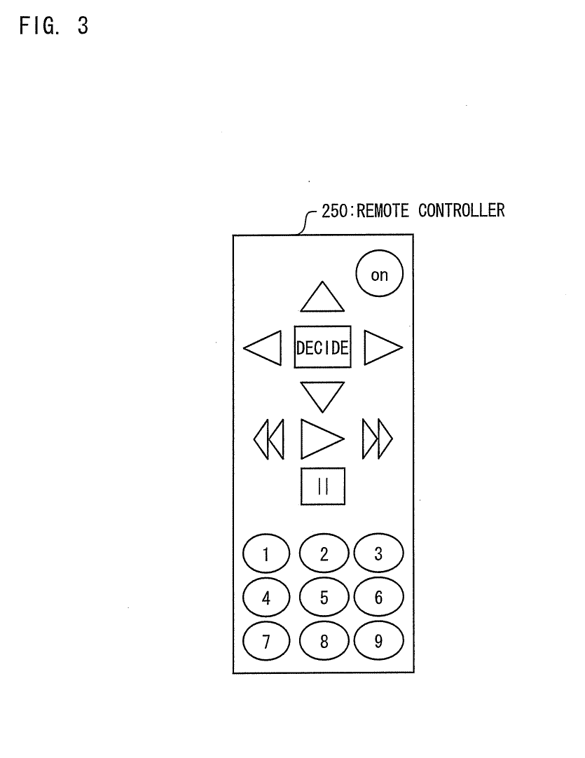

FIG. 1 is a functional block diagram illustrating a configuration of an image display device (information processing device) 100A of the present embodiment. FIG. 2 is a block diagram illustrating a hardware configuration of the image display device 100A. FIG. 3 is an explanatory diagram of a remote controller 250 for operating the image display device 100A.

The image display device 100 is a device that manages files which are stored, in folders, within the image display device 100 or a storage device outside the image display device 100.

As shown in FIG. 1, the image display device 100A is configured to include a display section 101, an operation obtaining section 102, and a UI (user interface) processing section 103.

The display section 101 displays, on a display screen, images themselves or object specifying elements such as icons, thumbnails, or text strings each of which object specifying elements corresponds to an image or a folder that is an object for browsing.

These images and a folder structure may be provided in, for example, the display section 101 or the UI processing section 103 of the image display device 100A. Alternatively, the images and the folder structure may be provided on an image server externally connected via an interface such as a USB (universal serial bus) or on an image server connected to a network. Further, information on a hierarchical structure of folders and images may be provided on a device different from a device that stores image files.

The operation obtaining section 102 is for obtaining a user operation. The user operation is performed by use of a keyboard, a mouse, a keypad, or the like. Other than these, the user operation may be performed by use of a remote controller 250 (FIG. 3) that is a body different from a main body. In a case where a keyboard, a mouse, a keypad, or the like is used, an operation input section 201 obtains an operation by a user onto the keyboard, the mouse, the keypad, or the like. Further, in a case where the remote controller 250 is used, the operation input section 201 generally receives, by near field communication means such as infrared communication, a control signal that is outputted in accordance with a user operation.

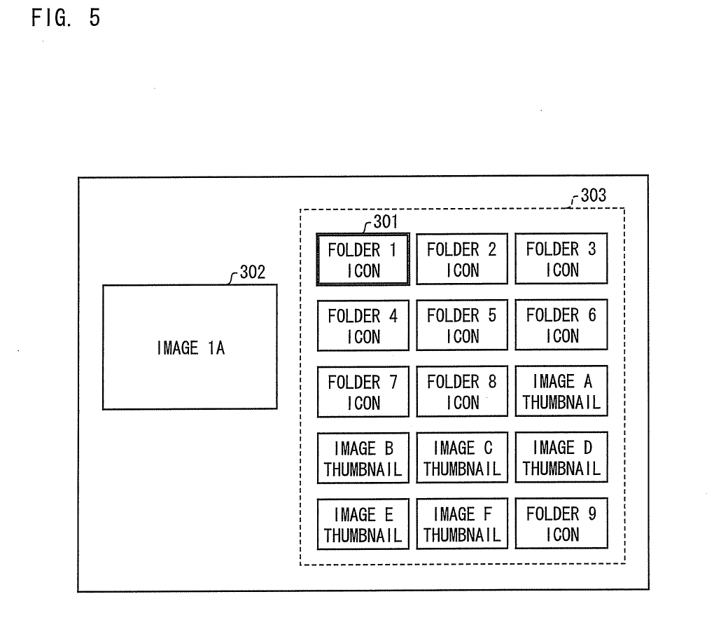

The UI processing section 103 detects a key event or the like as well as displaying a filer image as shown in FIG. 5, so as to provide a user with an operation environment for browsing files or the like. As shown in FIG. 5, the filer screen displayed by the UI processing section 103 includes an icon display area 303 and a preview display area 302. The icon display area 303 displays a list of folder icons indicative of folders and file icons (image thumbnails in a case where files are image files) indicative files (e.g. image files). The preview display area 302 displays a preview in accordance with a folder or a file that is selected by a user. Here, the icon display area 303 is arranged so as to allow a user to select an icon by use of a cursor. Hereinafter, a state where the cursor is placed on an icon is expressed by a term “select” and a state where a decision making (fixing) operation (e.g. input of a “decision” key”) is performed in the state where the icon is “selected” is expressed by a term “decide”. In accordance with “selection” or “decision” on an icon, the UI processing section 103 performs a process on a folder or a file corresponding to the icon.

In particular, the UI processing section 103 reads out image files directly under a folder that is selected by a user, and performs a slide show in which each image file is sequentially displayed.

As shown in FIG. 1, here, the UI processing section 103 particularly includes an icon display section (icon display means) 131, and a preview slide show executing section (preview slide show executing means) 133.

The icon display section 131 displays, in the icon display area 303 (FIG. 5) of a screen, a list of folder icons indicative of folders and file icons indicative of files (icon display process). Further, when a folder icon that is displayed in the list in the icon display area 303 is selected and this selection is decided, the icon display section 131 displays, in the icon display area 303, a list of files and folders stored in the folder icon.

The preview slide show executing section 133 displays, in the preview display area 302 that is in the same screen as the icon display area 303, a slide show of files stored in a folder corresponding to a folder icon selected from folder icons that are displayed by the icon display section 131 in a list in the icon display area 303 (preview slide show execution process). Note that the preview slide show executing section 133 displays the slide show display by a preview slide show execution thread.

Next, the following explains how functional blocks of the image display device 100a are related to hardware elements, with reference to FIGS. 1 and 2.

A CPU (central processing unit) 202 receives necessary information from a RAM (random access memory) 204 or a bus, according to a program, while sequentially reading out the program on a ROM (read only memory) 203, and then carries out drawing and display on a display panel 205 by using the necessary information; thereby the display section 101 is realized.

Further, the CPU 202 controls the operation input section 201 and receives necessary information via the RAM 204 or the bus, according to a program, while sequentially reading out the program on the ROM (read only memory) 203, and then stores data on the RAM 204 or transmits a message to another thread that is operating on the CPU 202, by using the necessary information; thereby the operation obtaining section 102 is realized.

The CPU 202 receives necessary information from the RAM 204 or the bus, according to a program, while sequentially reading out the program on the ROM 203, and then, by using the necessary information, carries out drawing and display on the display panel 205; thereby the UI processing section 103 is realized.

Here, data of folders and images are stored in, for example, the ROM 203, the RAM 204, or other storage device within the image display device 100A.

Note that how each functional block is related to the hardware elements explained here is merely one example, and other implementation method is also possible.

As shown in FIG. 3, the remote controller 250 is provided with various operation keys on a surface of a housing. The remote controller 250 transmits, to the main body of the image display device 100A, a predetermined control signal in accordance with a key operation by a user. More specifically, the remote controller 250 includes up/down/left/right direction keys for selecting an item by moving a cursor, a decision key for deciding an item selected, and a plurality of operation keys including character input keys or the like for inputting numbers and letters.

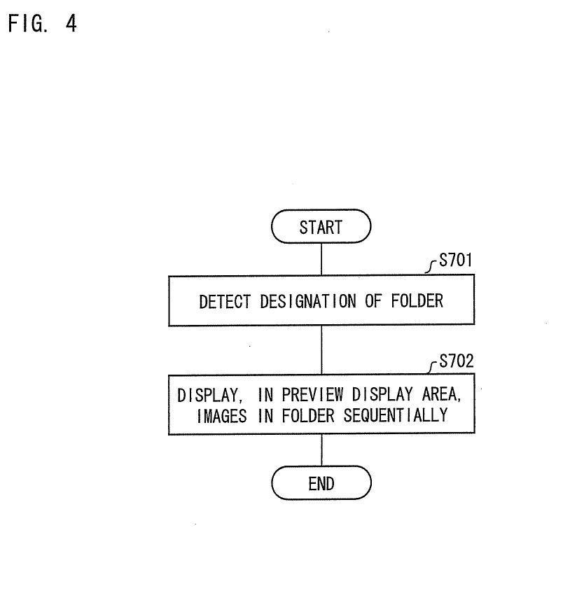

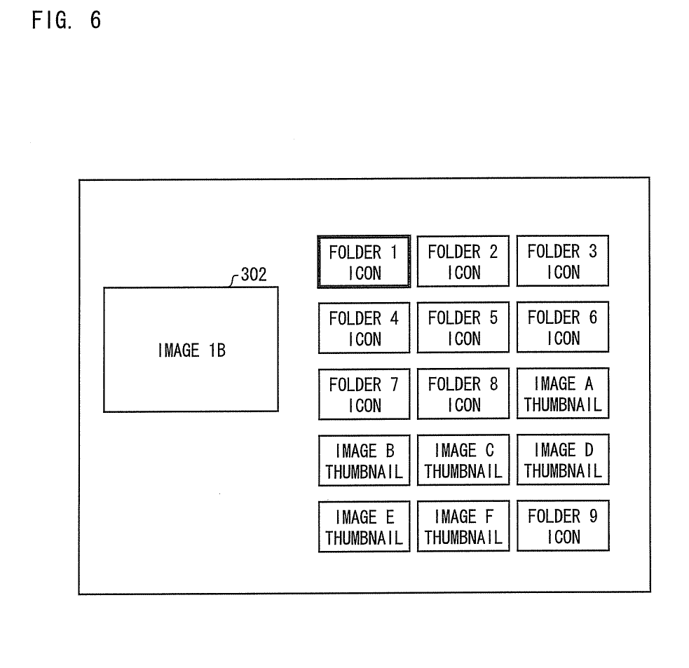

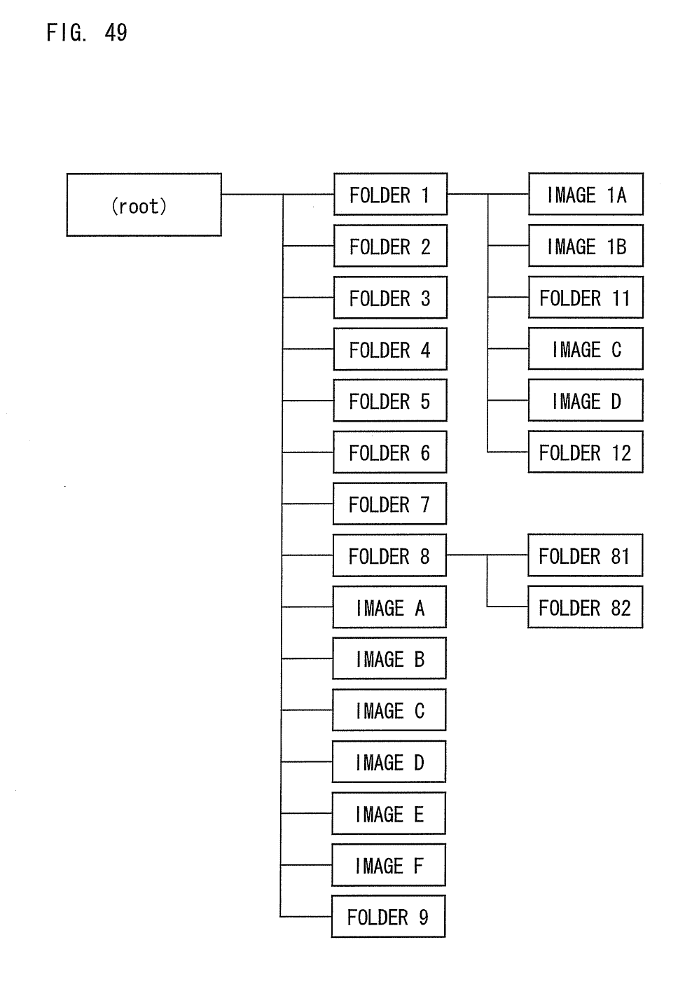

Next, with reference to FIGS. 4 to 6, the following explains an operation of the image display device 100A. FIG. 4 is a flowchart illustrating an operation of the image display device 100A. FIGS. 5 and 6 are explanatory diagrams illustrating exemplary display screens of the image display device 100A. Note that a tree structure of images and folders is the same as that shown in FIG. 49.

As shown in FIG. 5, first, when a user places a cursor 301 on an icon of a folder (here, a folder 1) that is displayed in a list in the icon display area 303 on a screen, the operation obtaining section 102 detects a specified folder and conveys a result of the detection to the preview slide show executing section 133 of the UI processing section 103 (S701).

Next, the preview slide show executing section 133 sequentially reads out images in the specified folder and displays a slide show in the preview area 302 that is provided in the same screen as the screen where folder icons and image thumbnails are displayed in the list (S702). In this slide show display, first, an initial image (here, an image 1A) in the folder is displayed (FIG. 5). Then, after a predetermined time has elapsed, that is, after the initial image is displayed for the predetermined period, a next image (here, an image 1B) is displayed (FIG. 6).

In this way, in the image display device 100A, all images in the folder, that is, images 1A to 1D in the case of the folder 1 in this example are sequentially displayed. After the last image is displayed, that is, the images are displayed up to the image 1D, the image 1A is displayed back again. Then, the display of the respective images is repeated until an operation for giving an instruction to stop the slide show is performed. Note that when the images have been displayed up to the image 1D, execution of the slide show may be stopped and the image 1D may be kept displayed.

Here, as shown in FIG. 5, a predetermined small area (the preview display area 302) for displaying images in a preview slide show is arranged to take a lager area as compared to areas for the folder icons and the image thumbnails. Further, the predetermined small area is not overlapped with the folder icons and the image thumbnails, and arranged in a separate area. This makes it possible to check and browse each image having a relatively large size in an easy-to-see state while which folder is currently viewed is being checked. Note that, when a cursor is placed on a thumbnail of an image (here, the image A), the thumbnail (preferably, an image having a larger size than the icons and the thumbnails displayed) of the image is displayed in the preview display area 302.

### Embodiment 2

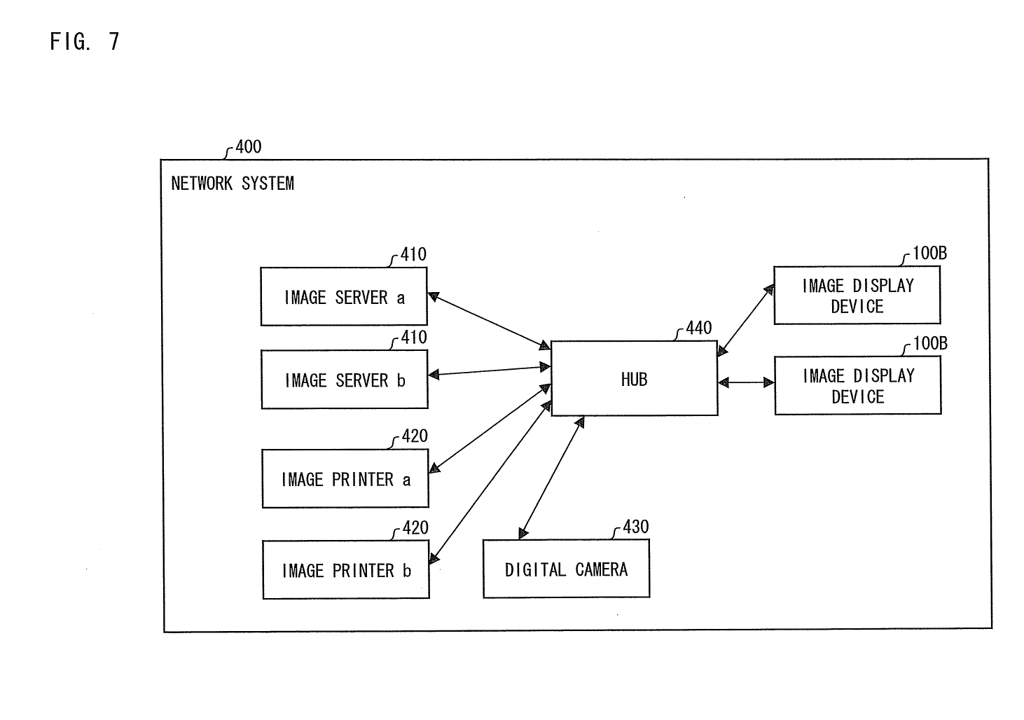

The following explains another embodiment of the present invention, with reference to FIGS. 7 to 26. Note that, for convenience of explanation, members respectively having the same functions as members in Embodiment 1 are denoted by the same reference signs, respectively, and explanations thereof are omitted. Further, regarding terms defined in Embodiment 1, definitions of such terms are also applied to the present embodiment unless specifically noted otherwise.

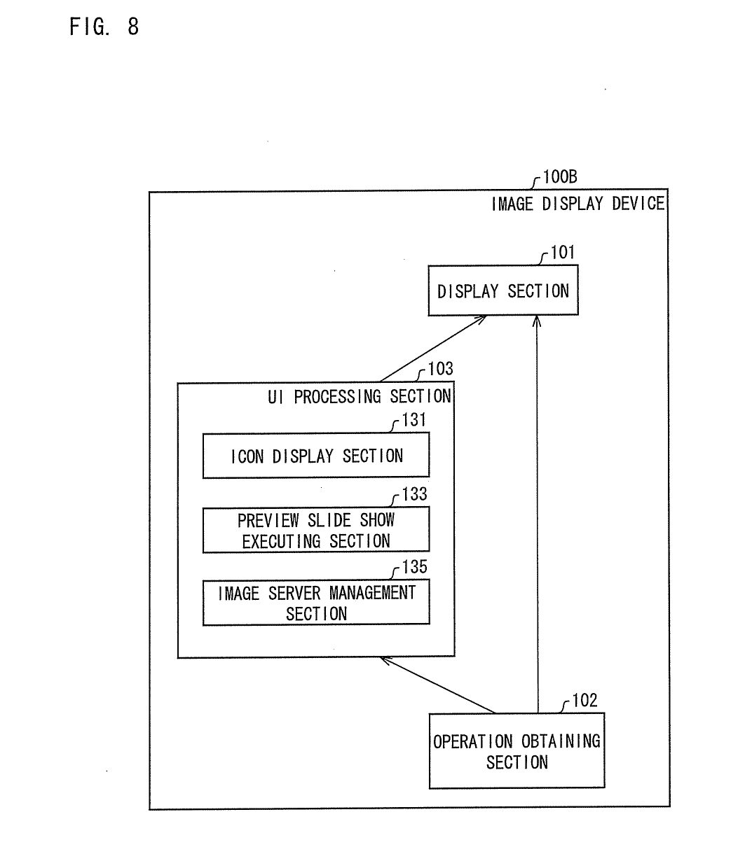

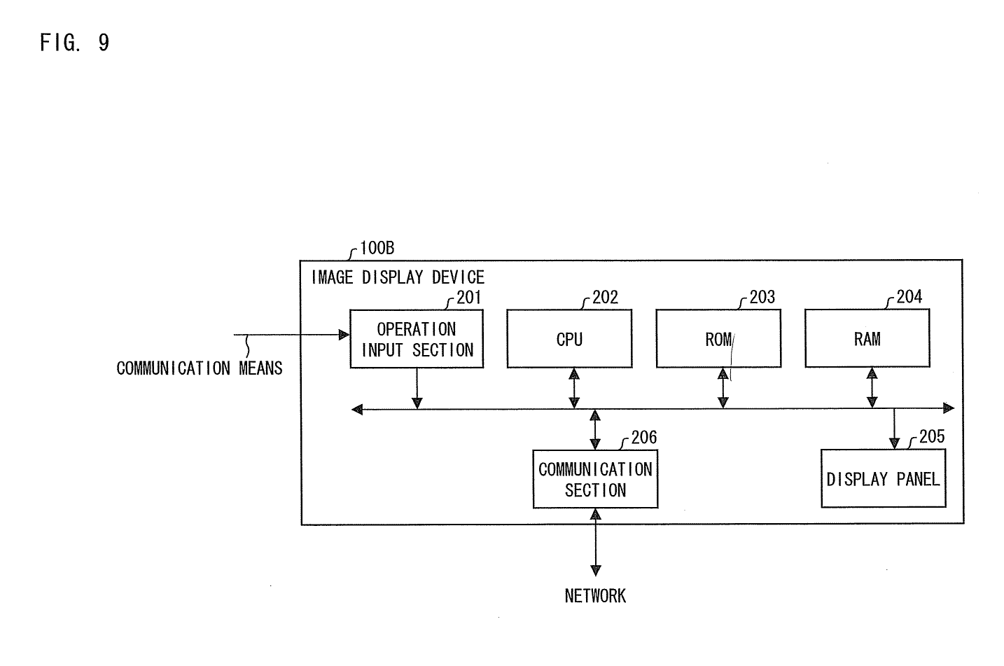

FIG. 7 is a configuration diagram illustrating a configuration of a network system 400 including an image display device 100B of the present embodiment. FIG. 8 is a functional block diagram illustrating a configuration of the image display device 100B. FIG. 9 is a block diagram illustrating a hardware configuration of the image display device 100B.

As shown in FIG. 7, the image display, device 100B is connected to a network. To this network, devices such as another image display device 100B, an image server 410, an image printer 420, and a digital camera 430 are connectable.

The image server 410 stores therein images and folders that store images. Note that in the present embodiment, though at least one device providing images to the image display device 100B, for example, the image server 410 or the digital camera 430 is essential, other device is not necessarily required to be connected. Further, here, a hub 440 is used to connect each device. However, other relay device may be used for the connection. Alternatively, connection to the network may be implemented by other communication method such as a wireless LAN (local area network) or Bluetooth (Registered Trademark).

As described above, the image server 410 and/or the digital camera 430 each of which provides images to the image display device 100B are connected to the network system 400. Further, it is also possible to connect, as such a device connected to the network system 400, a multifunction FAX (that is, a FAX having a function as a network printer, which FAX is called an MFP (Multifunction Printer or a multifunction FAX)). In other words, it is possible to connect a FAX that can not only receive image data via the network and print an image of the image data but also, connecting to a telephone line and receiving a FAX image, store and print the FAX image. Further, among multifunction FAXes, there is a FAX that has a memory card slot and can function to transmit images stored in the memory card slot via the network. The multifunction FAX having such a memory card slot can have both functions of a DMS and an image printer.

FIG. 8 is a functional block diagram briefly illustrating a configuration of the image display device 100B according to the present embodiment.

As shown in FIG. 8, the UI processing section 103 particularly includes an image server management section (server management means) 135, in addition to an icon display section (icon display means) 131 and a preview slide show executing section (preview slide show executing means) 133. Note that the icon display section 131 and the preview slide show executing section 133 are identical to those in Embodiment 1 and therefore, explanations thereof are omitted.

The image server management system 135 searches for servers (in FIG. 7, image servers a and b and a digital camera) from which the image display device 100B can obtain files, and allows a user to select a server that is to be used by the user. Note that the image server management system 135 searches for such servers by an image server table generation thread. A process of this search for servers by the image server table generation thread can be carried out in the background. Further, the image server management section 135 retains an image server table generated by the image server table generation thread.

Next, the following explains how the functional blocks of the image display device 100B are related to hardware elements, with reference to FIGS. 8 and 9.

A CPU (central processing unit) 202 receives necessary information from a RAM (random access memory) 204 or a bus, according to a program, while sequentially reading out the program on a ROM (read only memory) 203, and then carries out drawing and display on a display panel 205 by using the necessary information; thereby the display section 101 is realized.

Further, the CPU 202 controls the operation input section 201 and receives necessary information via the RAM 204 or the bus, according to a program, while sequentially reading out the program on the ROM (read only memory) 203, and then stores data on the RAM 204 or transmits a message to another thread that is operating on the CPU 202, by using the necessary information; thereby the operation obtaining section 102 is realized.

The CPU 202 receives necessary information from the RAM 204 or the bus, according to a program, while sequentially reading out the program on the ROM 203, and then, by using the necessary information, carries out drawing and display on the display panel 205; thereby the UI processing section 103 is realized.

Here, the folder and image data are stored in, for example, the image server 410 that is connected to the network, and obtained via the network by a communication section 206. The data obtained via the network is processed by the display section 101 and the UI processing section 103 via the bus.

Note that these folders or containers are not necessarily required to correspond to physical folders, directories, or the like of the image server 410, but a virtual folder configuration may be generated according to a predetermined condition in the image server 410. For example, the image server 410 may generate a folder named “Apr. 10, 2007” and put images captured on Apr. 10, 2007 in this folder, regardless of a physical directory configuration on an actual hard disk. In a system that combines such an image server 410 and the image display device 100B, a user needs to check and browse only a folder that is meet conditions and therefore can more easily and quickly check and browse necessary images.

Note that how each functional block is related to the hardware elements explained here is merely one example, and other implementation method is also possible.

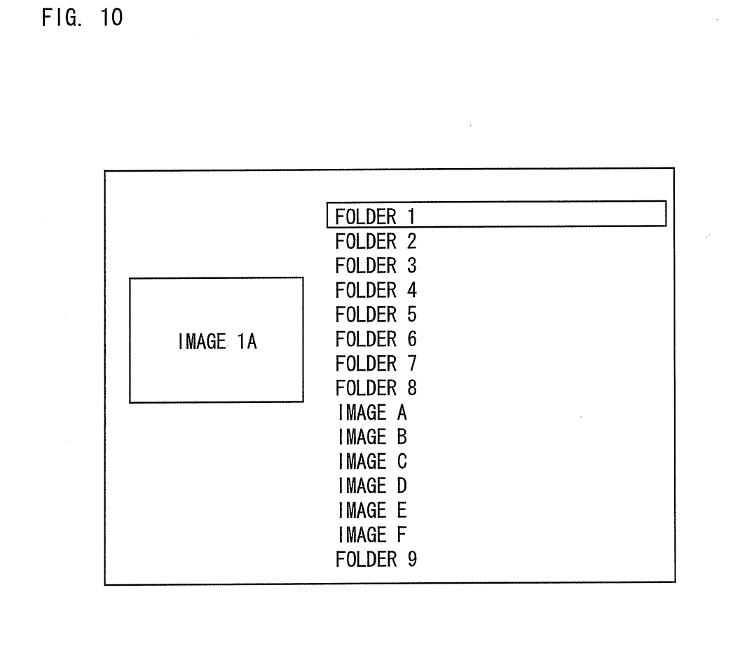

Next, an operation of the image display device 100B is explained with reference to FIGS. 10 to 30.

FIG. 10 is an explanatory diagram illustrating an exemplary display screen of the image display device 100B. Note that a tree structure of images and folders is the same as that shown in FIG. 49.

On the display panel 205, for example, a screen shown in FIG. 5 is displayed, in accordance with placement of folders and images in the image server 410. Here, a small area indicated as an “image 1A” on the left side of FIG. 5 is a predetermined area (a preview display area 302) for displaying a preview image.

Other than icons as shown in FIG. 5, it is possible to display a list including descriptive expressions as shown in FIG. 10.

Alternatively, according to an operation input by a user, the display of the icons (FIG. 5) and the display of the list (FIG. 10) may be switched in a toggle manner. In this case, the user can use two display modes by switching between the display modes. For example, in a case where the user wants to briefly view image contents, the icons may be displayed. Meanwhile, in a case where the user wants to know images by referring to titles, the list may be displayed.

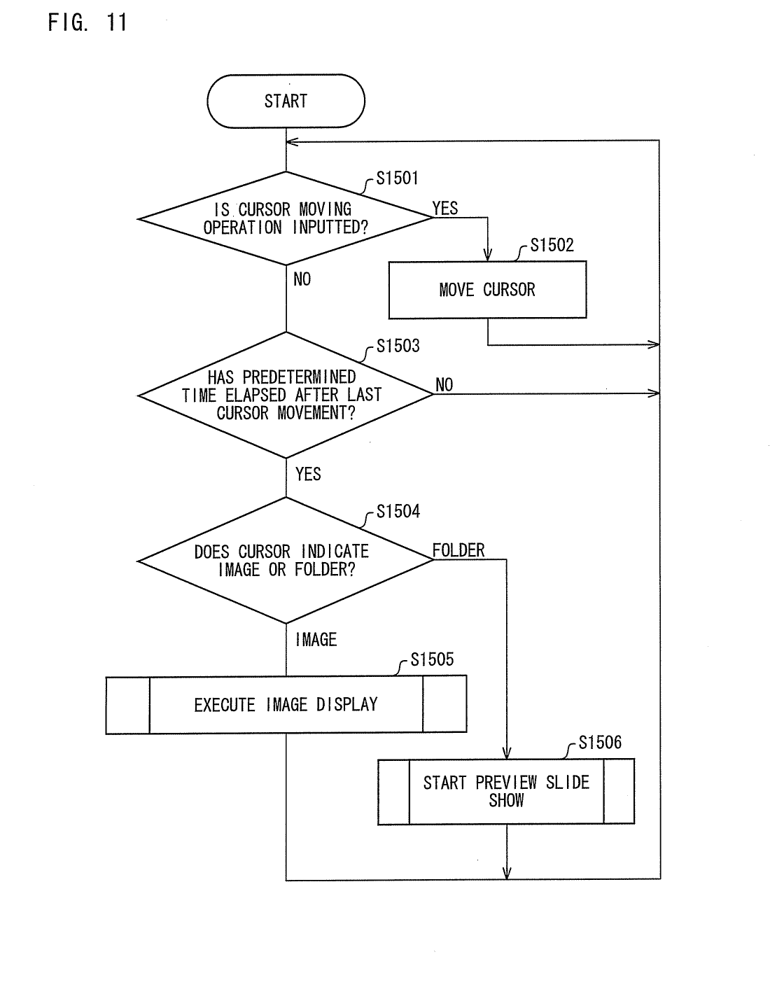

FIG. 11 is a flowchart illustrating an operation of the image display device 100B.

As shown in FIG. 11, first, the operation obtaining section 102 waits for a cursor moving operation by a user (S1501). When the cursor moving operation is performed, the operation obtaining section 102 moves a cursor on a screen (S1502). If a predetermined time elapses after the cursor is moved last (S1503), the operation obtaining section 102 determines whether the cursor is placed on an image thumbnail or a folder icon (S1504).

Next, if it is found that the cursor is placed on a folder icon (“folder” in S1504), display of a slide show of images in the folder is started in the preview display area 302 (S1506). On the other hand, if it is found that the cursor is placed on an image thumbnail (“image” in S1504), image display is executed (S1505).

A process of the cursor moving operation as described above is performed in parallel with a preview slide show. Therefore, after the execution of the image display (S1505) or the start of the preview slide show (S1506), the operation obtaining section 102 returns to the step of waiting for another cursor moving operation (S1501).

The parallel processing can be achieved by establishing separate threads on the CPU 202, respectively. Hereinafter, a thread for carrying out the preview slide show is referred to as a “preview slide show execution thread”.

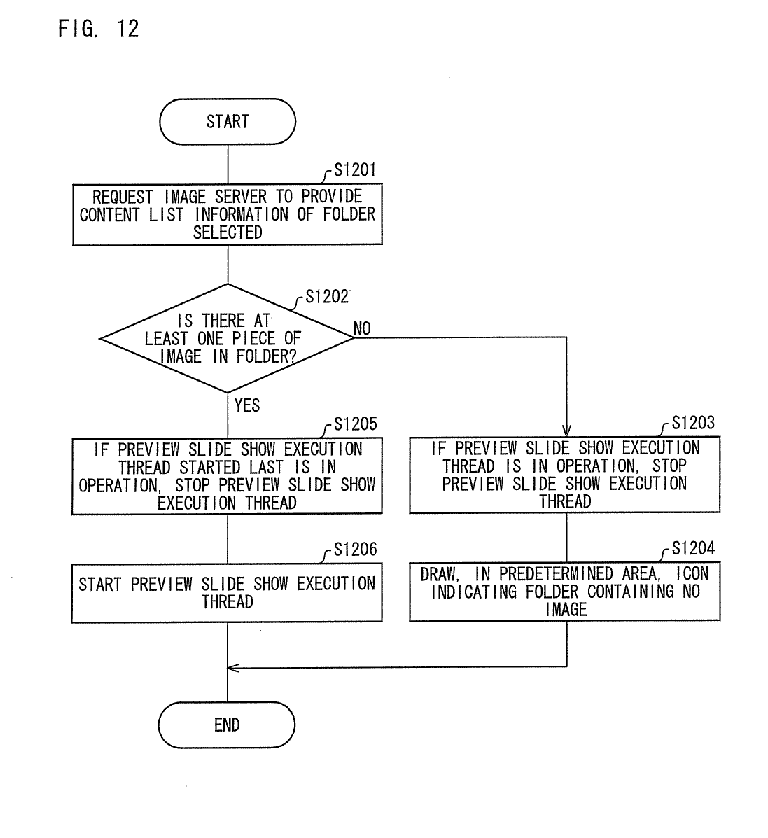

Next, a process for starting the preview slide show (S1506) is explained, with reference to a flowchart of FIG. 12.

First, a request for content list information of a folder selected is made to the image server 410 (S1201). Next, it is determined whether at least one piece of image is present in the folder or not (S1202). This determination is made by obtaining the content information list from the image server 410. Note that this content information list is explained in detail later.

Then, when at least one piece of image is present in the folder (Yes in S1202), the following steps are taken. That is, first, in a case where a preview slide show execution thread activated last is still in operation, this preview slide show execution thread activated last is stopped (S1205) and then another preview slide show execution thread is started (S1206).

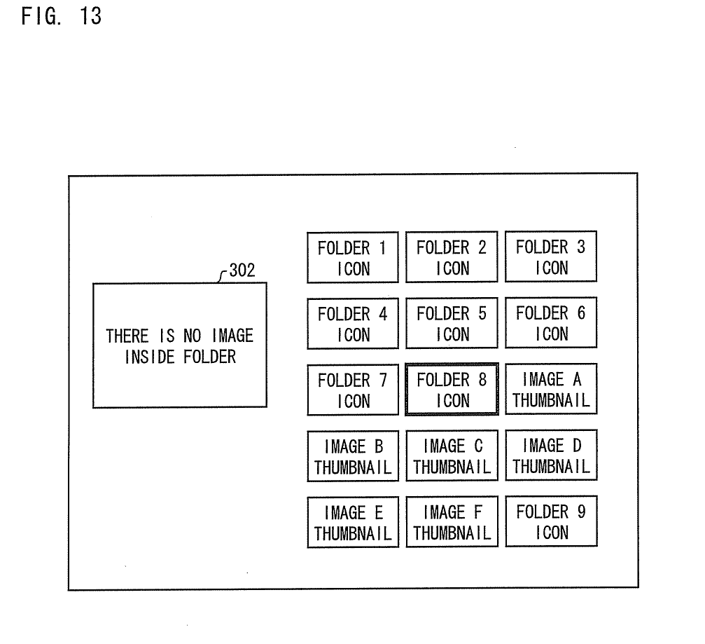

On the other hand, when no piece of image is present in the folder (No in S1202), the following steps are taken. That is, in a case where a preview slide show execution thread activated last is still in operation, this preview slide show execution thread is stopped (S1203) and then an icon (FIG. 13) indicating a folder containing no image is drawn in the preview display area 302 (S1204).

Note that, for example, in a case where an image file cannot be obtained because the network is disconnected or in a case where an image format is not a format that the image display device 1008 supports, an error message notifying as such may be displayed in the preview display area 302 as shown in FIG. 13.

Further, in a case where a time of a preset threshold or more is taken for obtaining an image due to a network load and/or other conditions, a message notifying that more time is required for obtaining the image or that it is required to wait for a while may be displayed in the preview display area 302. Alternatively, such an error message or a notification message may be displayed separately on a dialogue (not shown) or in a guidance area (not shown).

As a result of the display of such messages, a user can take a step to solve a problem; for example, the user can recover connection of the network from the disconnection. Alternatively the user can take a step of, for example, first checking and browsing images stored in other image server available. Therefore, checking and browsing of images by the user can be more easily or more quickly progressed.

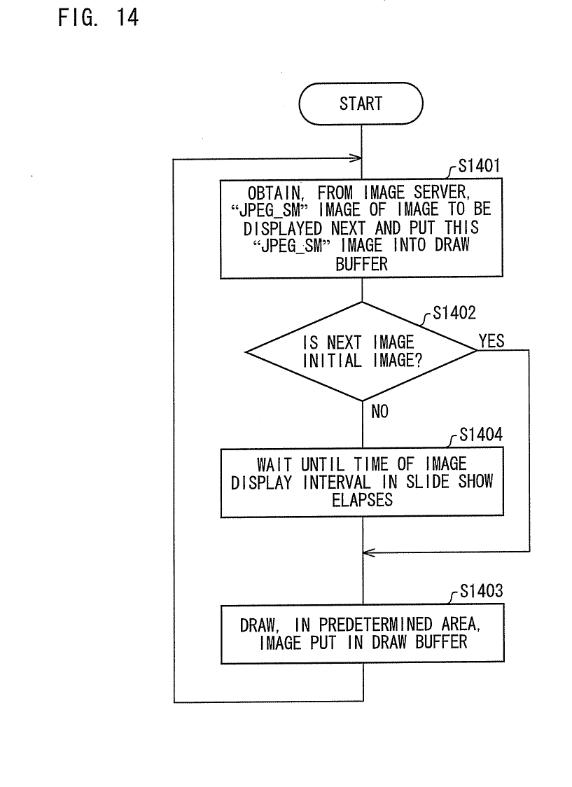

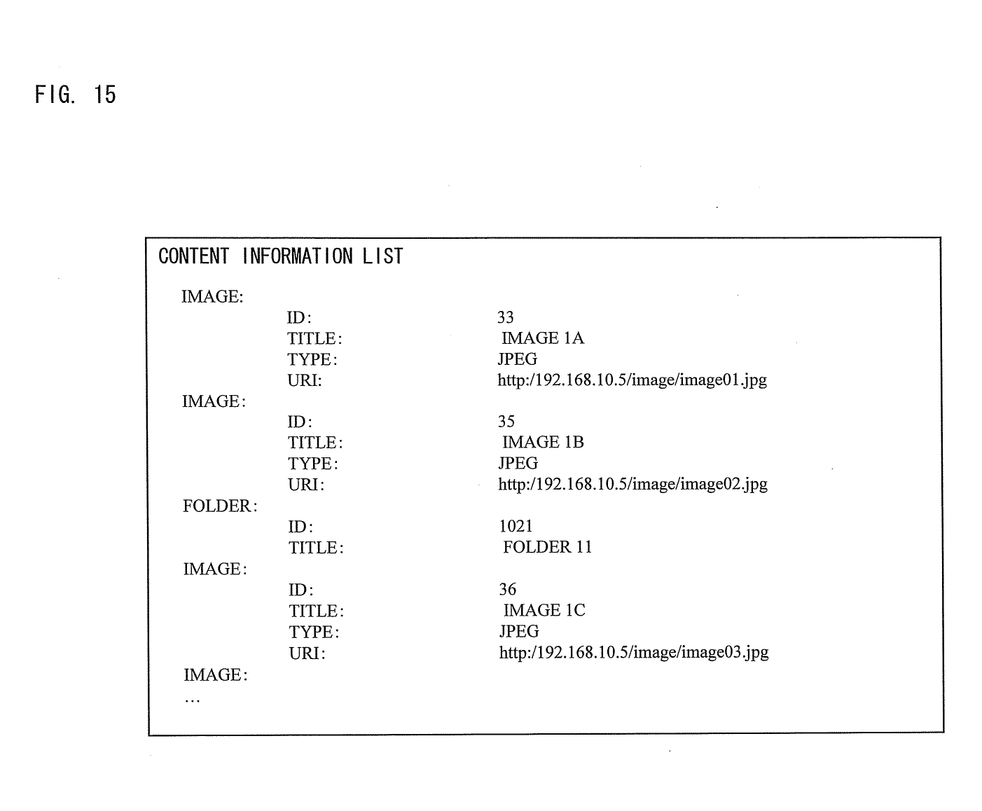

With reference to FIGS. 14 to 18, the following explains a process of the preview slide show execution thread. FIG. 14 is a flowchart of the process of the preview slide show execution thread. FIGS. 15 to 18 are explanatory diagrams of content information lists.

The preview slide show executing section 133 of the UI processing section 103 obtains a content information list as shown in FIGS. 15 to 18 from the image server 410, and executes a slide show of images according to the order arranged in the content information list.

In an example of FIG. 15, an initial image has an ID of “33”, an image title of “image 1A”, an image type of “JPEG”, and an image URI (uniform resource identifier) of “http:/192.168.10.5/image/image01.jpg”. The ID is for identification of the image. Similarly, the second image has an ID of “35”, an image title of “image 1B”, an image type of “JPEG”, and a URI of “http:/192.168.10.5/image/image02.jpg”. Similarly, the first folder has an ID of “1021” and a folder title of “folder 11”. The ID is for identification of the folder. Similarly, the third image has an ID of “36”, an image title of “image 1C”, an image type of “JPEG” and a URI of “http:/192.168.10.5/image/image03.jpg”. Note that, in FIG. 15, the fourth and subsequent images and the second and subsequent folders are omitted.

Here, the “ID” is a value given to each folder and each image by the image server 410 for uniquely identifying each folder and each image. This value is different for each folder and each image. The “title” is given by the image server 410 to each folder and each image. As the “title”, for example, a file name of each folder or each image on the image server 410 can be used. The same title may be given to different folders and images. The “image type” indicates an image format or the like such as JPEG (Joint Photographic Experts Group). As the image format, other than JPEG, PNG (Portable Network Graphics) or the like is possible.

Here, for example, the DLNA guideline provides definitions for JPEG such that: (i) a JPEG image of 640 pixels by 480 pixels or smaller is JPEG SMALL (JPEG_SM); (ii) a JPEG image larger than the JPEG_SM but not larger than 1024 images by 768 pixels is JPEG medium (JPEG_MED); and (iii) a JPEG image larger than JPEG_MED but not larger than 4096 pixels by 4096 pixels is JPEG large (JPEG_LRG). Here, “not larger than 640 pixels by 480 pixels” means that an image size has pixels not more than 640 pixels in length and pixels not more than 480 pixels in width.

The “URI” indicates a location where image data of such an image is placed. This URI typically indicates a location on the image server 410 but does not necessarily indicate a location on the image server 410. That is, the image server 410 may transmit a content information list including images whose actual image data is in other device.

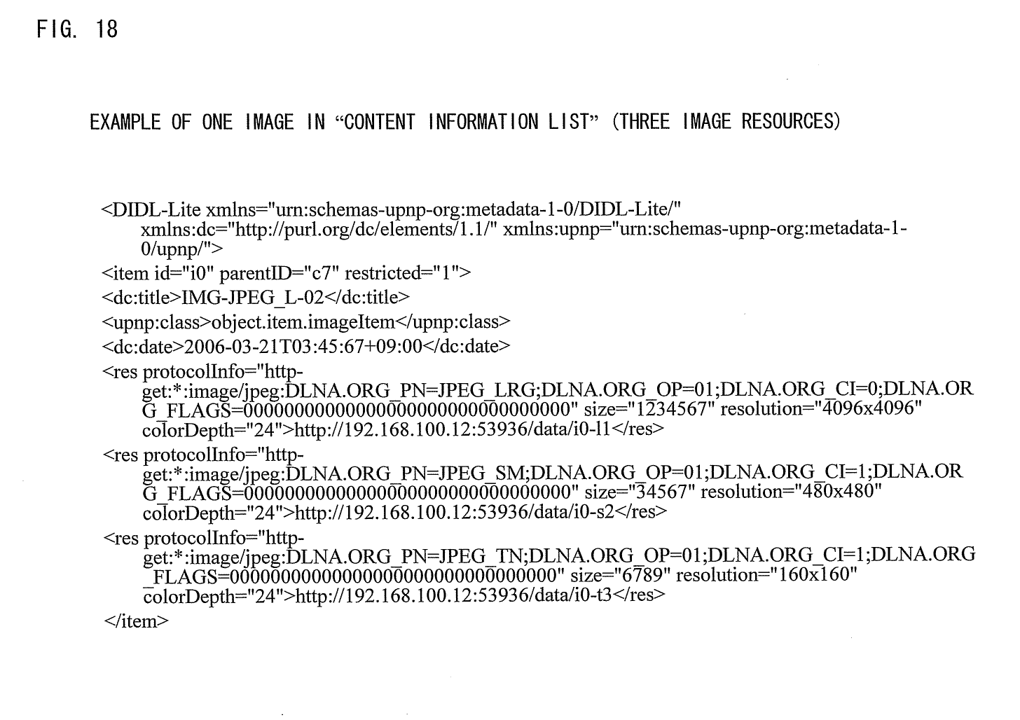

In the example shown in FIG. 15, the image data corresponding to each image is always one. However, as in the example of FIG. 18, each image may have one or a plurality of corresponding image resources. Here, though each of the image resources corresponds to image data, each image resource indicates not only the image data itself but also attribute data (e.g. the “ID”, “title”, “image type”, or “URI” described above) of the image data. Note that the example of FIG. 18 is an example of an image different from the images in the example of FIG. 15 or the like, and accordingly the data name, attribute, and the like of the example of FIG. 18 are not identical to those of the example of FIG. 15 or the like.

As described above, a plurality of image resources may be prepared. This is because it is not always appropriate to obtain an original image of an original high resolution due to difference in image processing performance or image display performance depending on DMPs or due to a restriction on a capacity of the network.

In the case of the slide show in the image display device 100B, as shown in FIGS. 5, 6, and 13, the image size in display is within a predetermined size and smaller than a whole screen. Accordingly, it is better to obtain not an original image of an original high resolution but a smaller image, for saving a network frequency band, an image transfer time, hardware or software resources for processing, or the like.

According to the DLNA guideline, a DMS is always required to prepare a JPEG_SM image. Accordingly, for example, in a case where a “JPEG_SM” image is to be always displayed, it cannot happen that an image of a “JPEG_SM” resolution is not prepared in trial for obtaining such an image. Further, an image captured by a typical digital camera is often larger than “JPEG_SM”. In such a case, as described above, it is possible to save a network frequency band, an image transfer time, hardware or software resources for processing or the like.

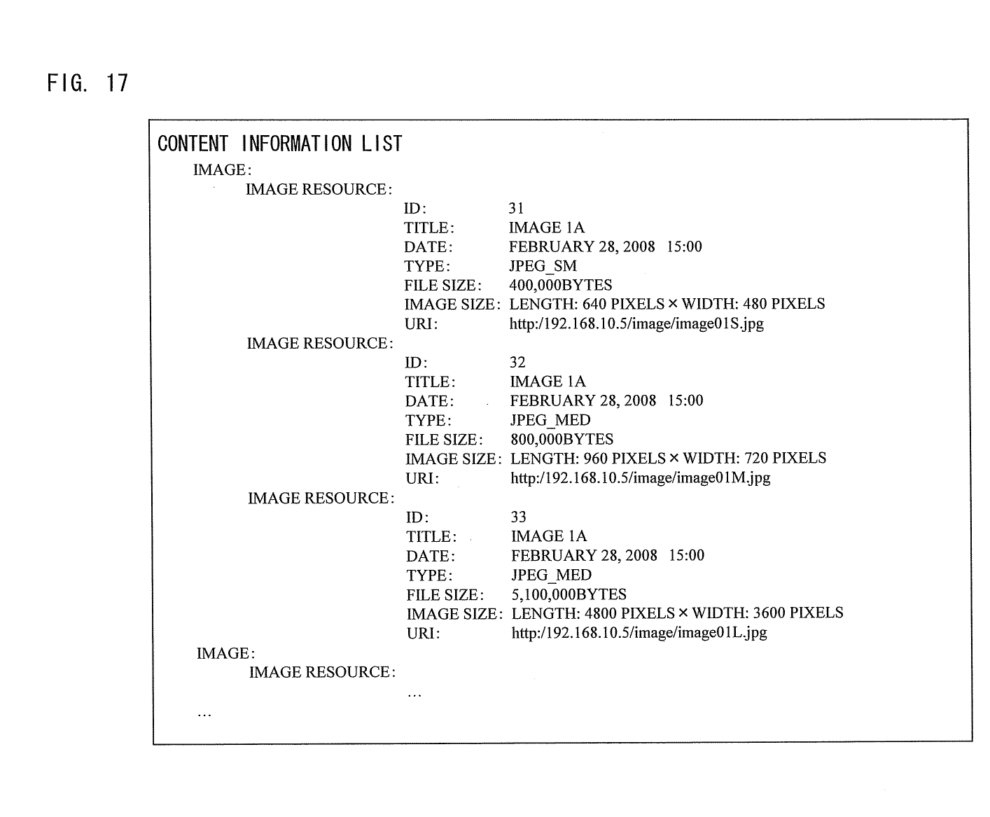

Further, in the example of FIG. 17, information on the “date”, a “file size” and an “image size” is added. By using the information, for example, it is possible not to display, as an error, an image having a file size that is larger than a predetermined file size or an image having an image size that is larger than a predetermined image size.

As shown in FIG. 14, by the preview slide show execution thread, first “JPEG_SM” image data of an image to be displayed next is obtained from the image server 410, and this “JPEG_SM” image data is inputted into a draw buffer (S1401). The “JPEG_SM” image data is obtained by making an access to a corresponding URI indicated in a content information list by use of a communication protocol indicated in the URI. In examples of FIGS. 14 to 18, this communication protocol is HTTP (hyper text transfer protocol). Note that, in a case the image data to be obtained here is “JPEG_SM” image data, the above effects can be obtained. However, the image data to be obtained here is not necessarily “JPEG_SM” image data.

Next, in a case where the next image is an initial image (Yes in S1402), the image put in the draw buffer is drawn in the preview display area 302 (S1403). Meanwhile, in a case where the next image is not an initial image (No in S1402), the thread waits until a time of an interval between image displays of a slide show elapses (S1404). After the elapse of the time, the image put in the draw buffer is drawn in the preview display area 302 (S1403). Note that if hardware exclusive for drawing is used, the image can be drawn within a short period.

Here, as shown in FIG. 5, a predetermined small area (the preview display area 302) for displaying images in a preview slide show is arranged to take a larger area as compared to areas for the folder icons and the image thumbnails in an icon list screen. Further the predetermined small area is not overlapped with the folder icons and the image thumbnails and arranged in a separate area in the icon list screen. This makes it possible to check and browse each image having a relatively large size in an easy-to-view state while which folder is currently viewed is being checked.

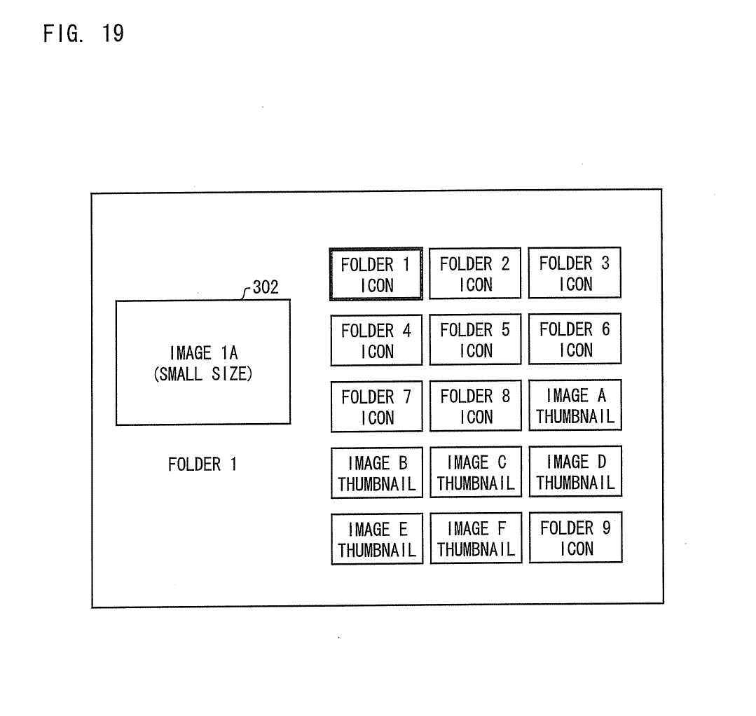

FIG. 19 is an explanatory diagram illustrating an exemplary display screen of the image display device 100B. Note that a tree structure of images and folders is the same as the structure shown in FIG. 49.

As shown in FIG. 19, in the vicinity of the preview display area 302 where a preview slide show of images are displayed, a folder name of the current folder may be displayed. The example of FIG. 19 has display that reads “folder 1” under the preview display area 302. As a result of such display, a user can easily find which folder is currently displayed.

This display image is kept displayed for a predetermined period (S1404). By using this predetermined period, a next image may be obtained from the image server 410. Here, the “next image” is an image arranged in a position next to the image currently displayed, in the content list information obtained from the image server 410. Here, as described above, image data whose image type is “JPEG_SM” in image resources is obtained.

Note that the image data to be obtained is not necessarily required to be “JPEG_SM”. Further, the “next image” is not necessarily required to follow the order in the content list information but may be in the order on another basis. An example of such order is the order of dates.

Further, in the preview slide show, all images in a folder are sequentially displayed. For example, in a case where four images, i.e., images 1A to 1D are present in a folder 1, the images 1A to 1D are sequentially displayed. After the images has been displayed up to the image 1D, the image 1A is displayed back again. Then, the display of the respective images is repeated in the same order until an operation for giving an instruction to stop the slide show is performed. Alternatively, after the images has been displayed once up to the image 1D, the slide show may be ended.

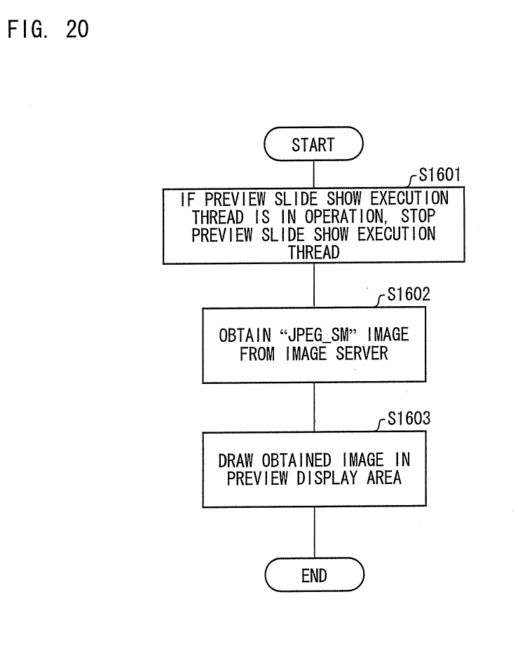

Next, with reference to a flowchart of FIG. 20, an image display execution process (S1505 of FIG. 11) is explained.

First, in a case where a preview slide show execution thread is already in an operation, the preview slide show execution thread is stopped (S1601). Then, from the image server 410, “JPEG_SM” image data is obtained from image resources of an image on which a cursor is placed (S1602). Here, the image data obtained is not necessarily required to be “JPEG_SM”.

Next, a “JPEG_SM” image obtained in the step S1602 is drawn in the predetermined small area (the preview display area 302) (S1603).

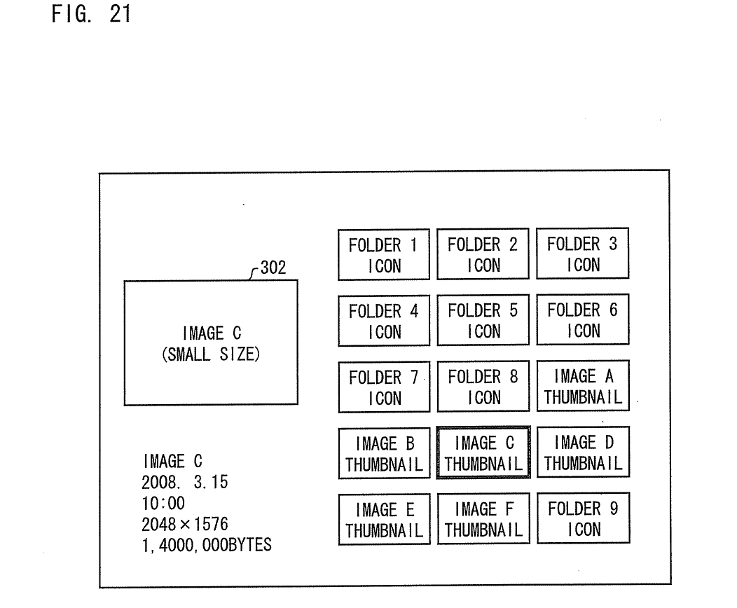

Here, as shown in FIG. 21, in the vicinity of the preview display area 302, attributes such as an image title, the date on which the image is captured, an image size, and a file size may be displayed. As a result of such display, a user can obtain more information on the image that is currently displayed. For obtaining attribute data of such attributes, the image display device 100B only needs to be arranged so that the image display device 100B can obtain the content list information (FIG. 17) from the image server 410.

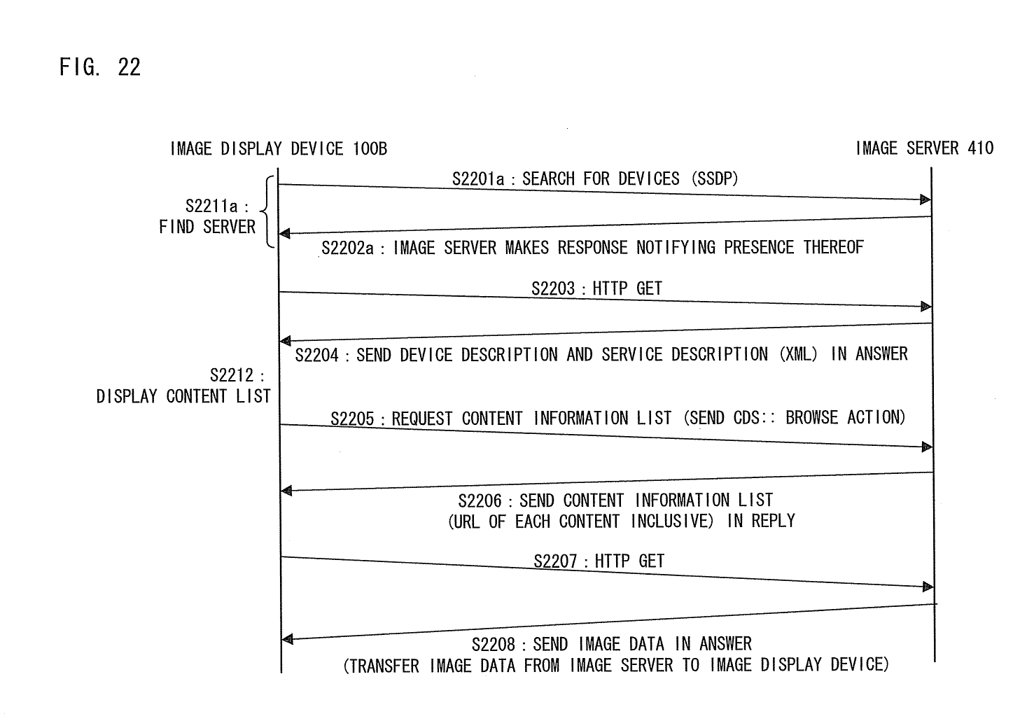

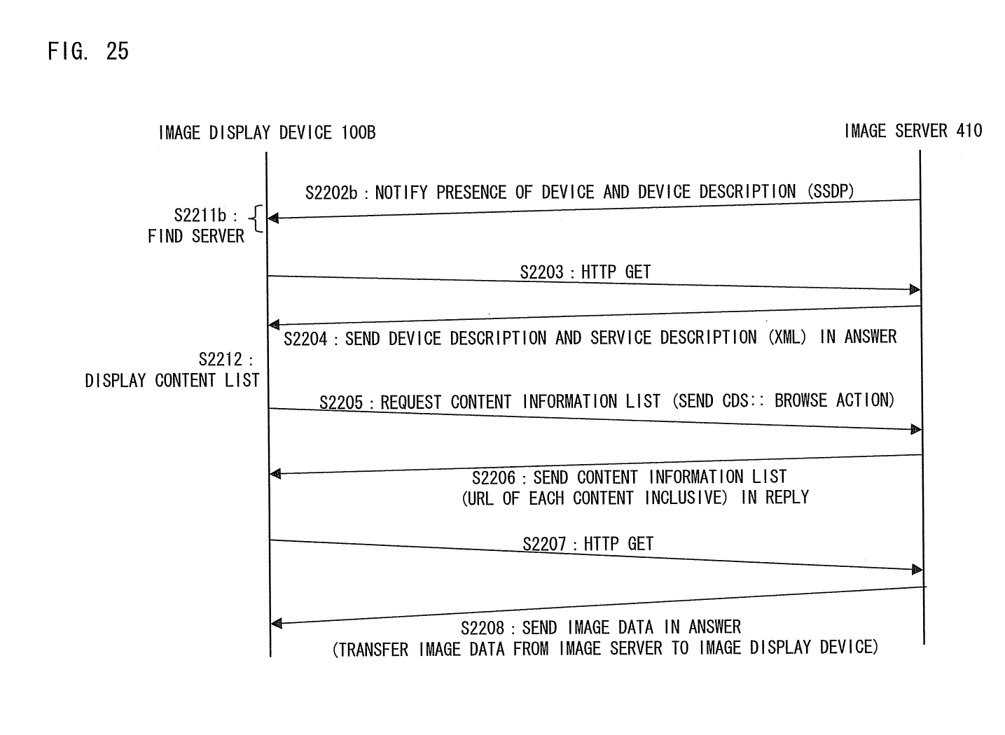

With reference to FIGS. 22 to 26, the following briefly explains exchange of information and data on the network between the image display device 100B and the image server 410. FIG. 22 is a sequence diagram in a case where the image display device 100B first transmits a message for searching for devices in the network by multicasting. FIG. 25 is a sequence diagram in a case where the image server 410 first transmits a message for notifying the presence of the image server 410 in the network by multicasting.

First, the image display device 100B needs to find the image server 410 on the network (S2211a or S2211b). Here, in the sequence of FIG. 22, the image display device 100B transmits a message for searching for devices in the network by multicasting (S2201a), and the image server 410 responds to the message (S2202a). Meanwhile, in the sequence of FIG. 25, the image server 410 transmits a message notifying the presence of the image server 410 in the network by multicasting, and thereby the image display device 100B recognizes the presence of the image server 410 (S2202b). Note that the sequence of FIG. 25 is different from the sequence of FIG. 22 in that S2201a and S2202a in the sequence of FIG. 22 is replaced by S2202b in the sequence of FIG. 25, and other subsequent steps are the same.

In this way, the image display device 100B has protocols for both the sequences. Accordingly, in a case where the server 410 is on the network earlier than the image display device 100B and the image display device 100B is added to the network subsequently (or the image display device 100B is turned on subsequently or the like), the image display device 100B can recognize the presence of the image server 410 according to the sequence of the steps S2201a and S2202a. On the other hand, in a case where the image display device 100B is on the network earlier than the image server 410 and the image server 410 is added to the network subsequently (or the image server 410 is turned on subsequently or the like), the image display device 100B can recognize the presence of the image server 100 according to the sequence of the step S2202b of FIG. 25.

Then, the image display device 100B transmits HTTP GET (S2203) based on information obtained by the sequence (S2201a and S2202a, or S2202b) for finding the image server 410 as described above, so as to obtain a device description (including a server name and a URI of an icon) of the image server 410 and a service description of the image server 410 (S2204). This allows the image display device 100B to obtain information on a service that the image server 410 provides.

Note that the sequence of the steps S2201a, S2202a, S2203, and S2204, and S2202b corresponds to an initial process that completes typically within an initial stage.

Next, the image display device 100B obtains the content information list from the image server 410 when a user specifies a folder. More specifically, the image display device 100B requests the image server 410 selected by the user to send the content information list (S2205) and the image server 410 sends the content list information in reply in response to the request (S2206).

Note that, for example, in a case where there are 1000 images in a folder and 20 images are displayed in one screen, a content information list including information required for each one screen may be obtained, for example, first for 1^{st} to 20^{th} images, secondly 21^{st} to 40^{th} images, etc., or alternatively a content information list including information on the 1000 images may be obtained at one time. Further, the content information list may be stored in the image display device 100B. Alternatively, the image display device 100B may always obtain a content information list from the image server 410 every time a user specifies a folder.

Subsequently, the image display device 100B requests the image server 410 to send the image data by use of HTTP GET (S2207), and in response to this request, the image server 410 transfers the image data (S2208). As a result, the image data is obtained.

Note that in the sequences explained above, though the step of the initial process, the step of obtaining the content information list, and the step of obtaining the image data are carried out in the above order and each step is carried out only once, these steps can be carried out as appropriate according to need. Further, the sequences illustrate only rough outlines, and information and data may be exchanged as appropriate other than in the above steps.

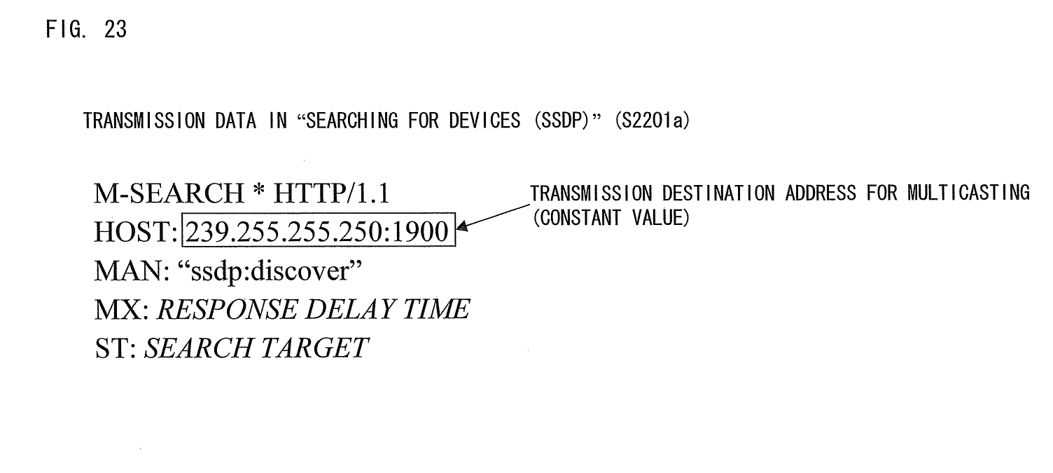

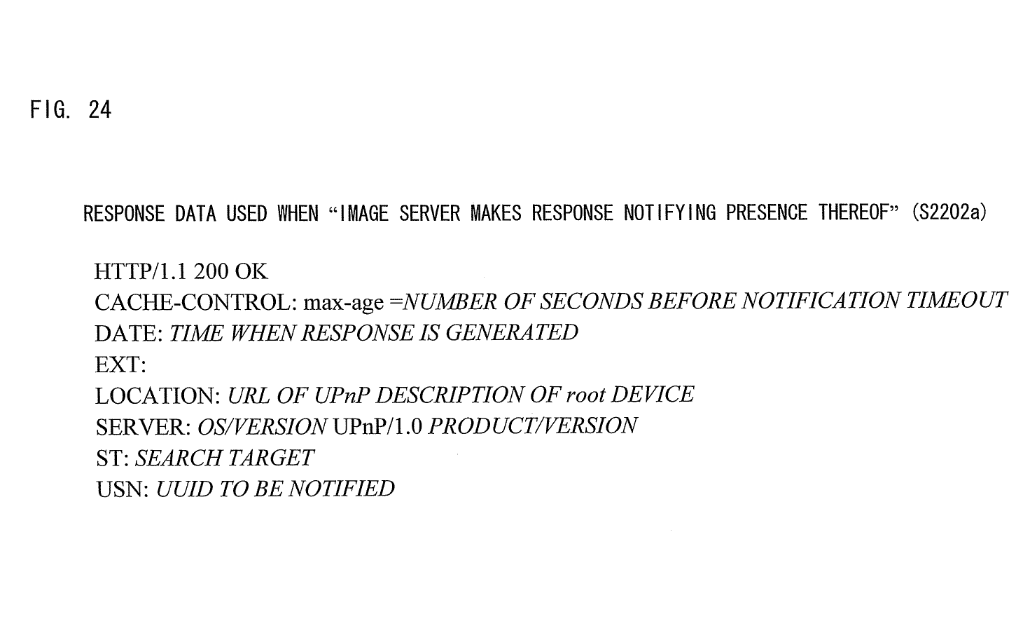

FIGS. 23 and 24 are explanatory diagrams illustrating in detail examples (examples according to UPnP Device Architecture standard) of transmission data used in the initial process in the sequence, as shown in FIG. 22, in a case where the image display device 100B first transmits a message for searching for devices in the network by multicasting.

As shown in FIG. 23, in the transmission data used in “searching for devices (SSDP (Simple Service Discovery Protocol))” (S2201a), a transmission destination address (fixed value) for multicasting is set in “HOST” based on UPnP (Universal Plug and Play) (registered trademark). Further, as shown in FIG. 24, in the transmission data used when “the image server makes a response notifying the presence of the image server” (S2202a), a URL (Uniform Resource Locator) of a device description of the image server 410 is set in “LOCATION”.

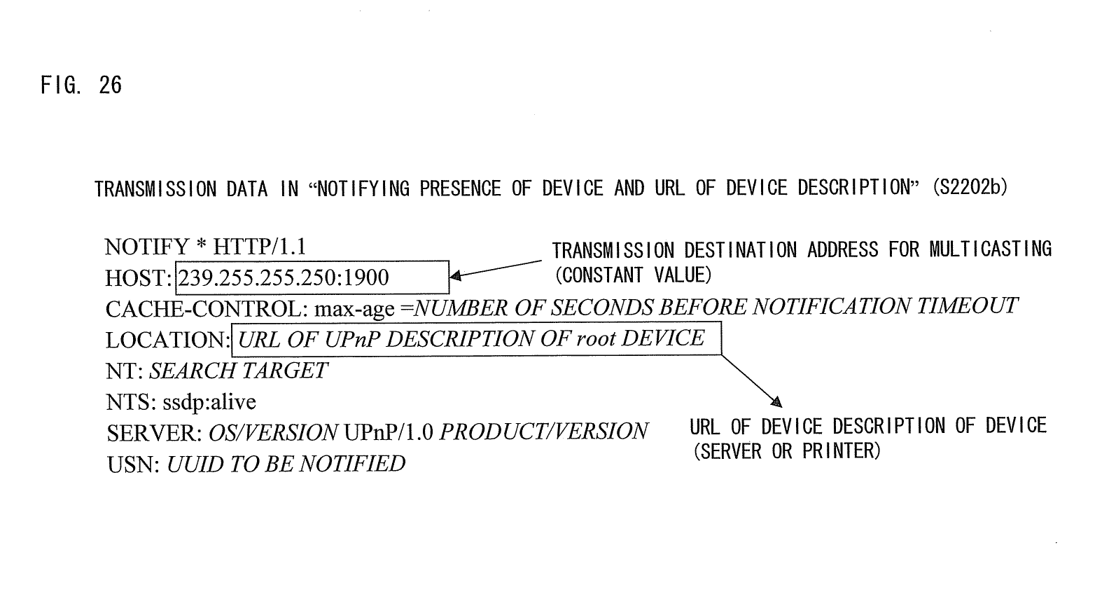

FIG. 26 is an explanatory diagram illustrating in detail an exemplary transmission data (an example according to UPnP Device Architecture standard) that is used in the initial process of the sequence, as shown in FIG. 25, in a case where the image server 410 first transmits a message notifying the presence of the image server 410 in the network by multicasting.

As shown in FIG. 26, in the transmission data used in “notifying the presence of a device and a URL of a device description (SSDP)” (S2202b), a transmission address (fixed value) for multicasting is set in “HOST” based on UPnP. In addition, the URL of the device description of the image server 410 is set in “LOCATION”.

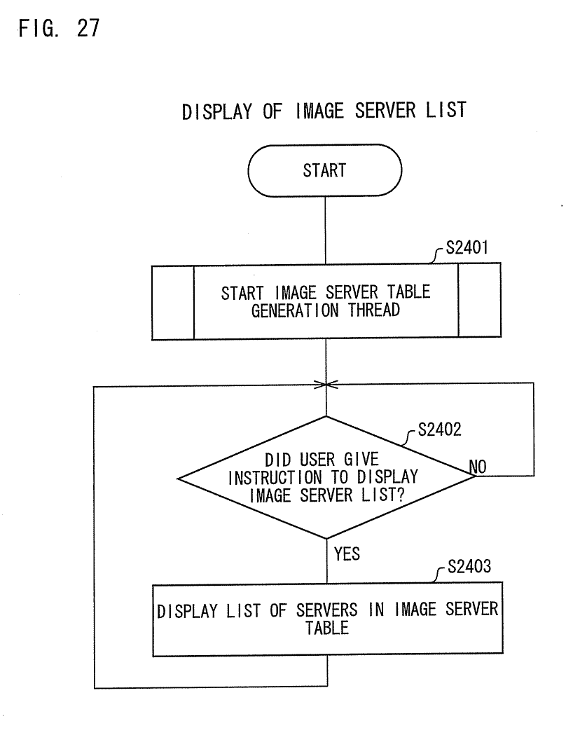

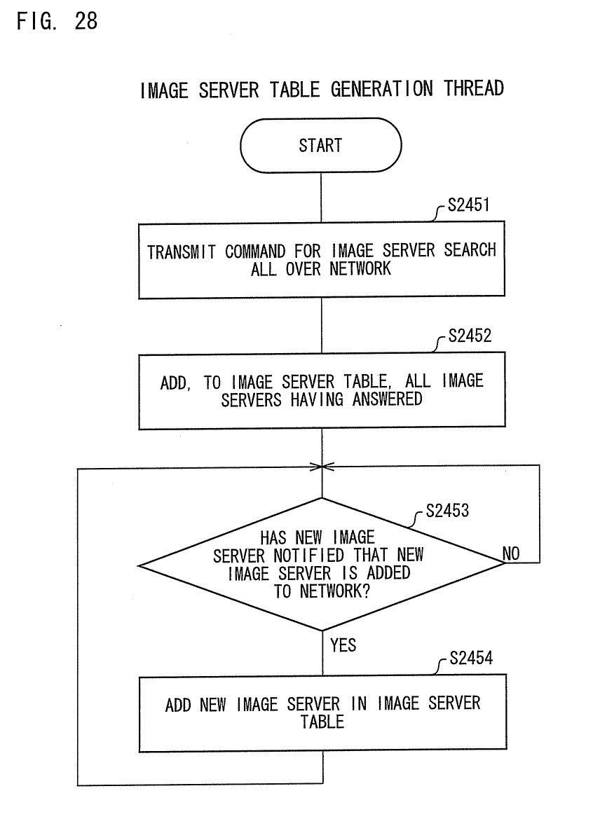

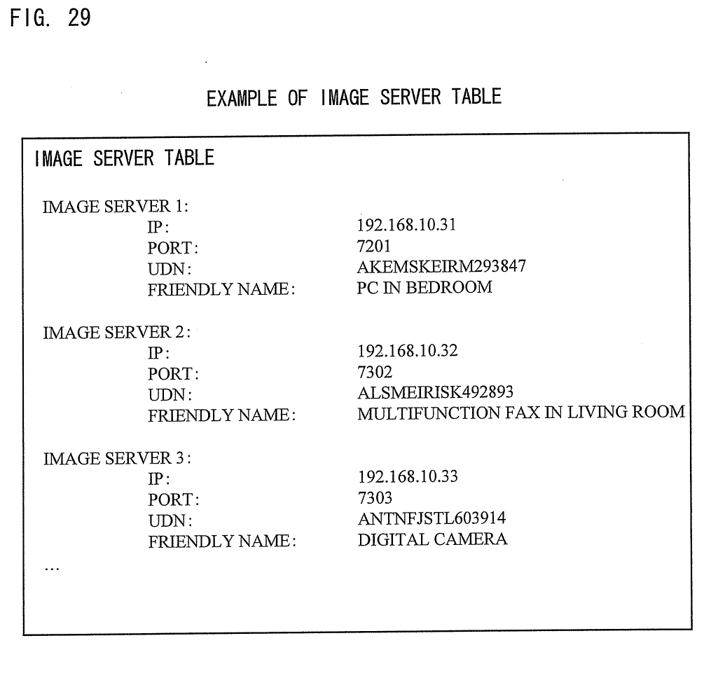

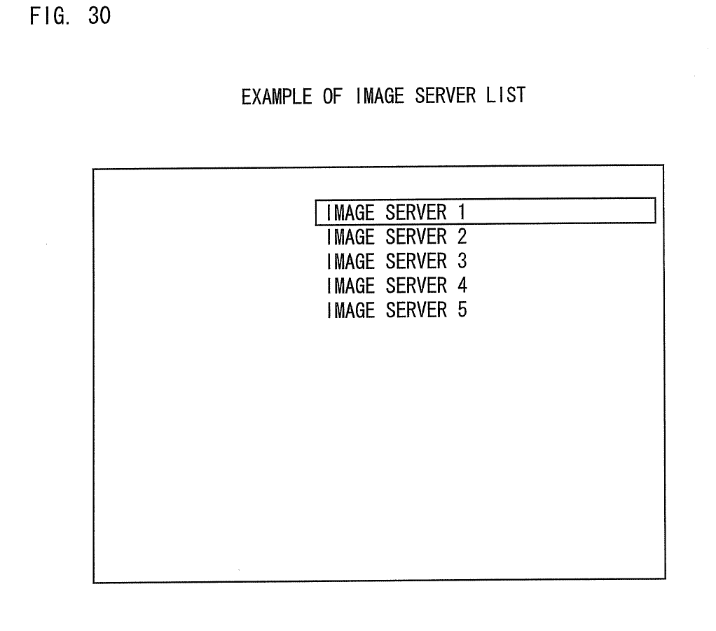

Further, with reference to FIGS. 27 through 30, the following explains a process for displaying an image server list by the image display device 100B. FIG. 27 is a flowchart of the process for displaying the image server list. FIG. 28 is a flowchart of an image server table generation thread. FIG. 29 is an explanatory diagram illustrating a specific example of an image server table. FIG. 30 is an explanatory diagram illustrating a specific example of the image server list.

As shown in FIG. 27, the image display device 100B starts an image server table generation thread (S2401), for example, when the image display device 100B is started. Note that the image server table generation thread started here can be continuously kept operating thereafter.

Then, when the image display device 100B receives from a user an instruction to display an image server list (Yes in S2402), the image display device 100B displays a list of image servers (FIG. 30) according to an image server table (FIG. 29) that is generated by the image server table generation thread (S2403).

The following explains a process of the image server table generation thread, with reference to FIG. 28.

First, the image display device 100B transmits a command for searching for image servers all over the network (S2451). Then, the image display device 100B adds, to the image server table, all image servers that have responded (S2452). Subsequently, every time the image display device 100B receives a notification from an image server that is newly added to the network (Yes in S2453), the image display device 100B adds this image server to the image server table (S2454).

Here, as shown in FIG. 29, in the image server table, an “IP (internet protocol)” indicative of an IP address of each image server detected, a “port”, a “UDN (unique device name)”, and a “friendly name” are registered. Note that in the example of FIG. 29, a “PC in a bedroom”, a “multifunction FAX in a living room”, and a “digital camera” are registered as image servers.

Further, as shown in FIG. 30, in the image server list, a list of devices that are capable of providing images are displayed so that a user can select such a device. Then, by using this image server list, the user selects a device from which the user is to receive images.

Here, the image display device 100B does not initially have information on devices that are connected to the network. Therefore, the image display device 100B searches for other devices that are connected to the network. This search can be performed according to a method defined in, for example, UPnP Device Architecture that is referred to in the DLNA (Digital Living Network Alliance) guideline.

Note that in this DLNA, for a case where images and image folders are placed, according to home network standards of DLNA guideline or the like, in a separate device from a display device, there is a known method in which a DMP (Digital Media Player) and a DMS (Digital Media Server) are used for displaying and browsing, on the DMP, images placed in the DMS.

Further, the DLNA guideline defines a method in which images of a plurality of resolutions are prepared for one original image and a list of such images are presented to the DMP. Such a method is defined in the DLNA guideline, for the following reason.

In general, in a case where images are obtained via the network, there occur problems in a necessary network frequency band, a communication time for images, and a time for necessary image processing. In recent years, a resolution of an image that can be captured by a digital camera has become higher, and such a resolution is often higher than a resolution that can be displayed in a display section of the DMP. Therefore, in a case where captured image data as it is transmitted from the DMS to DMP, an unnecessary network frequency band is used and a time for image transfer becomes unnecessarily long. In addition, in such a case, an image reducing process becomes necessary for displaying the image in the display section of the DMP.

In order to solve the above problems, images of lower resolutions are generated on the DMS. As a possible method for generating images of lower resolutions, the images of lower resolutions may be generated in advance or, after a request from the DMP is received, such images of lower resolutions may be generated.

However, the DMS is not always connected to the same type of DNP. Depending on cases, the DMS may be connected to another type of DMP. In such a case, images of higher resolutions may be displayed. Further, even in one type of DMP, display of images of higher resolutions may be possible depending on a mode setting or the like.

According to the DLNA guideline, images of a plurality of resolutions are prepared so as to correspond to one original image, and a list of such images can be presented to the DMP. Accordingly, viewing such image information, the DMP can decide image data to be obtained and make an access to a URI of the image data. As a result, the DMP can actually obtain the image data. Note that what is presented and transmitted to the DMP is not image data itself but only a list of images. Therefore, a communication volume becomes very small. The list of the images includes a URI (Uniform Resource Identifier) for an access to each image data, and image information such as a resolution of each image.

Note that in a case where a DMS that has the memory card slot is connected to a multifunction FAX that functions as both a DMS and an image printer, it is possible to print an image in a memory card and obtain the image that is outputted by printing immediately on briefly checking the image in the memory card on a large television screen.

### Embodiment 3

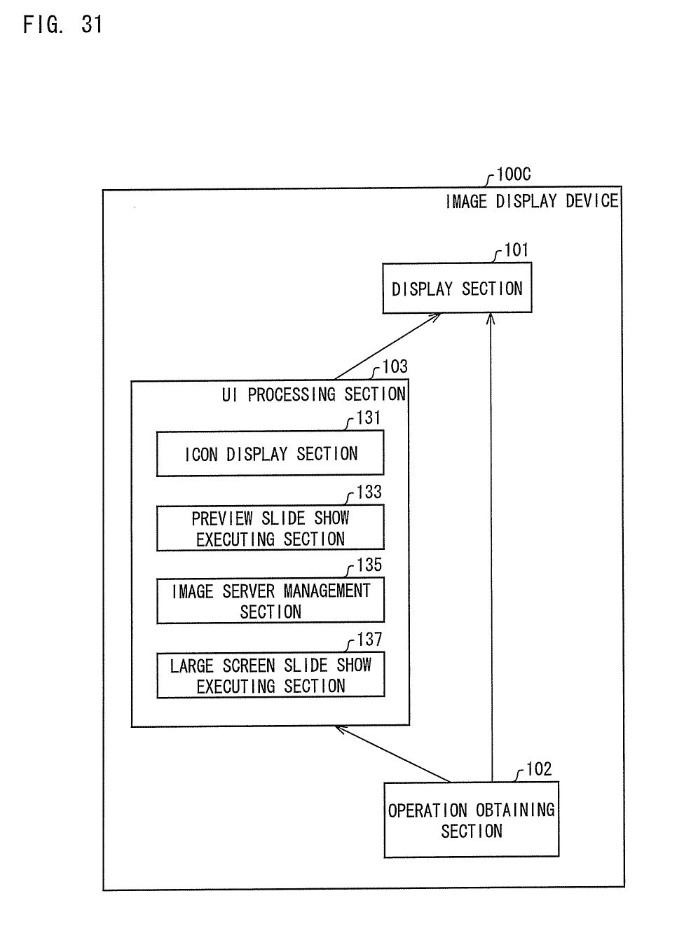

The following explains still another embodiment of the present invention with reference to FIGS. 31 to 38. Note that for convenience of explanation, members respectively having the same function as members in Embodiments 1 and 2 are denoted by the same reference signs, respectively, and therefore explanations thereof are omitted. Further, regarding terms defined in Embodiments 1 and 2, the definitions of such terms are also applied to the present embodiment unless specifically noted otherwise.

The present embodiment is obtained by adding, to Embodiment 2, a function for performing a large screen slide show on a full screen or by using an area whose dimension is large and close to that of the full screen, in addition to a preview slide show in a preview display area 302. More specifically, in the present embodiment, when an image thumbnail is clicked, the large screen slide show is performed. Note that checking and browsing of image data on an image server 410 are the same as in Embodiment 2, and therefore explanations thereof are omitted.

FIG. 31 is a functional block diagram briefly illustrating a configuration of an image display device 100C of the present embodiment.

As shown in FIG. 31, an UI processing section 103 particularly includes a large screen slide show executing section (large screen slide show executing means) 137 in addition to an icon display section (icon display means) 131, a preview slide show executing section (preview slide show executing means) 133, and an image server management section (server management means) 135. Note that the icon display section 131, the preview slide show executing section 133, and the image server management section 135 are the same as those in Embodiments 1 and 2, and explanations thereof are omitted.

When a file icon is selected from a list that is displayed in the icon display area 303 by the icon display section 131 and the selection of the file icon is decided, the large slide show executing section 137 displays, in a screen that is different from the icon display area 303, a slide show of files stored in a folder including a file corresponding to the file icon. Note that the large screen slide show executing section 137 displays a large screen slide show by a large screen slide show execution thread.

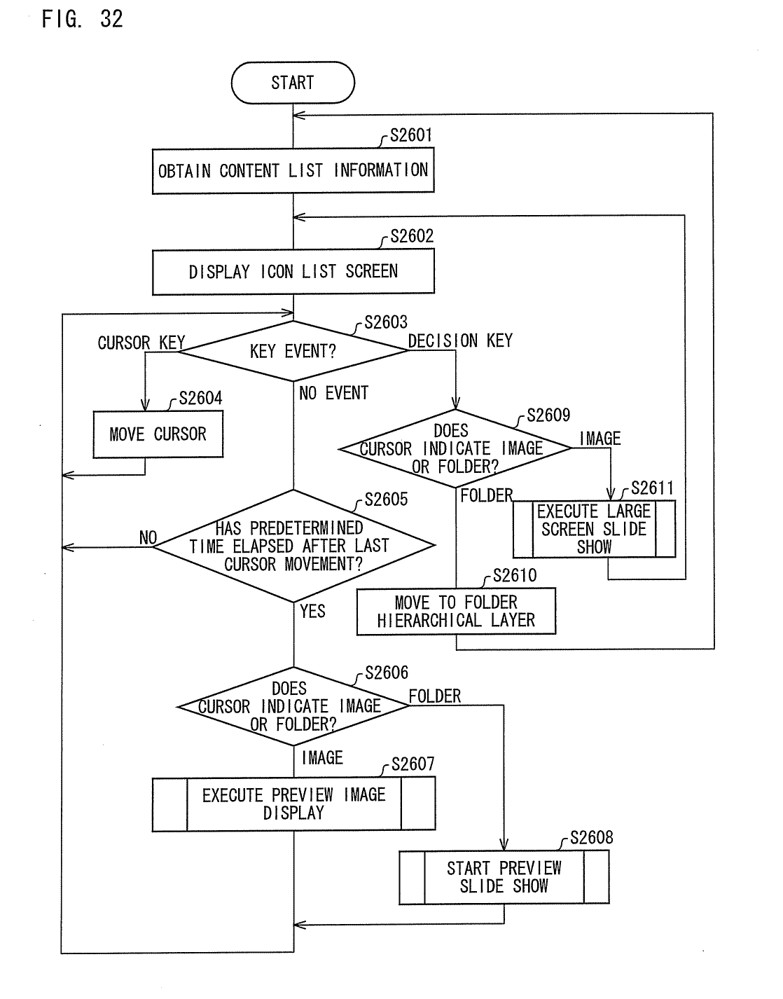

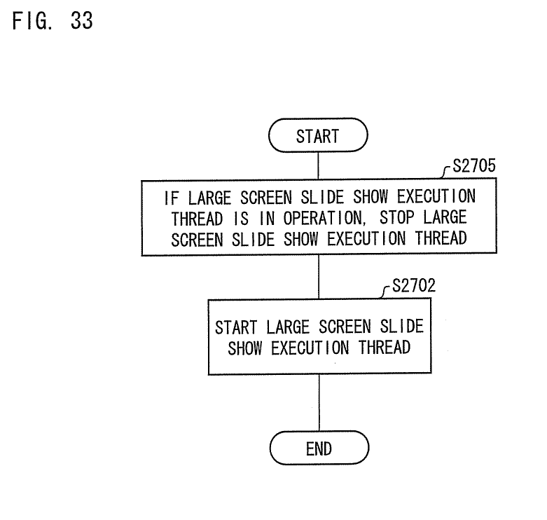

FIGS. 32 and 33 are flowcharts illustrating an operation of the image display device 100C.

As shown in FIG. 32, first, the image display device 100C obtains content list information from the image server 410 (S2601) and displays an icon list screen (FIG. 5) (S2602).

Then, the image display device 100C continuously waits for the occurrence of a key event (S2603) in the icon list screen. In a case where an input of a cursor key is detected (“cursor key” in S2602), the image display device 100C moves a cursor (S2604) and then returns to a state in which the image display device 100C waits for another key event (S2603). On the other hand, in a case where no key event occurs (no event in S2603) and a predetermined period has not yet been elapsed after last movement of the cursor (No in S2605), the image display device carries out no process and returns to a state where the image display device 100C waits for the occurrence of a key event (S2603).

Meanwhile, in a case where no key event occurs (“no event” in S2603) and a predetermined time has elapsed after last movement of the cursor (Yes in S2605), the image display device 100C determines whether a cursor is placed on an image or a folder (S2606). Then, if it is found that the cursor is placed on an image (image in S2606), the image display device 100C displays a preview image of the image in the preview display area 302 (S2607). On the other hand, if it is found that the cursor is placed on a folder (“folder” in S2606), the image display device displays a slide show of preview images of images in the folder in the preview display area 302 (preview slide show) (S2607). Note that after the step S2607 or S2608, the image display device 100C waits for the occurrence of a key event (S2603) while performing the display in the preview display area 302.

Alternatively, if an input of a decision key is detected as a key event (“decision key” in S2603), the image display device 100C determines whether the cursor is placed on an image or a folder (S2609). Then, if it is found that the cursor is indicating a folder (“folder” in S2609), the image display device 100C moves to a layer of the folder and displays a list of folder icons and image thumbnails indicative of the contents of the folder (S2610). Then, the image display device 100C returns to a state where the image display device 100C waits for the occurrence of a key event (S2603). On the other hand, if it is found the cursor is indicating an image (“image” in S2609), the image display device 100C starts execution of a large screen slide show (S2611). Note that when returning from the large screen slide show, the image display device 100C displays an icon list screen (S2602).

The following explains a process for starting the large screen slide show (S2608 of FIG. 32), with reference to FIG. 33.

As shown in FIG. 33, in a case where a large screen slide show execution thread that is activated last is still in an operation, the image display device 100C first stops the large screen slide show execution thread that is activated last (S2705). Then, the image display device 100C starts another large screen slide show execution thread (S2702).

Note that though, like a preview slide show, the large screen slide show is executed here by establishing a “large screen slide show” thread, a program may be arranged such that operations are successively carried by one thread without establishing no additional thread. This is because a hierarchical configuration of folders and images is not displayed during execution of the large screen slide show.

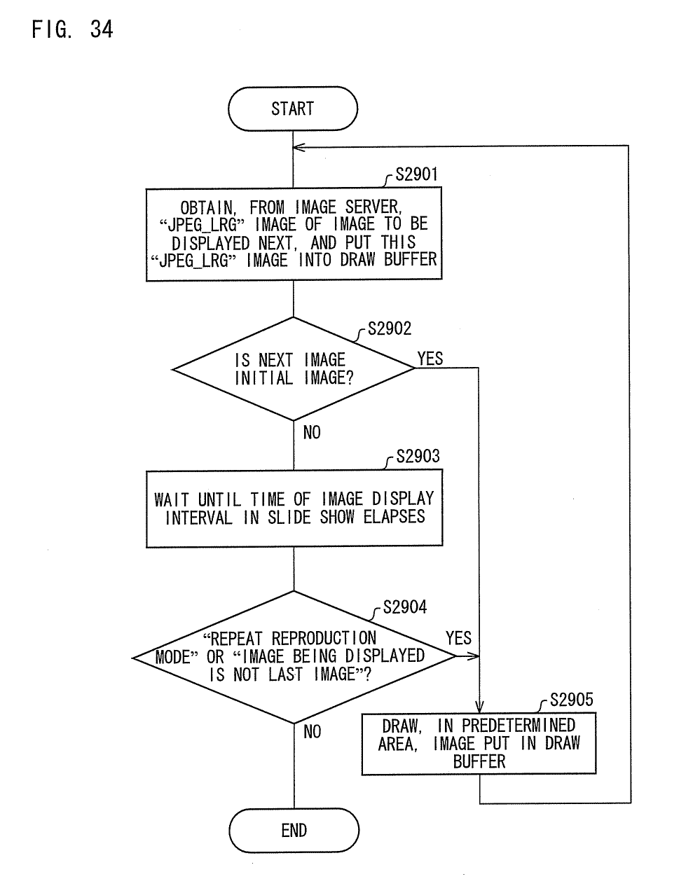

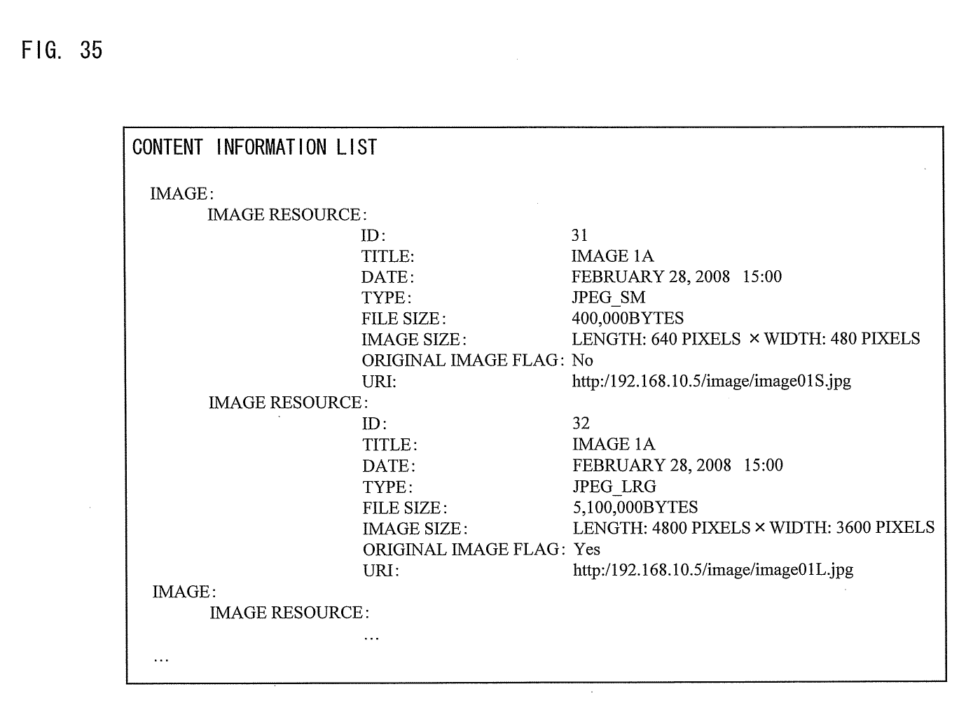

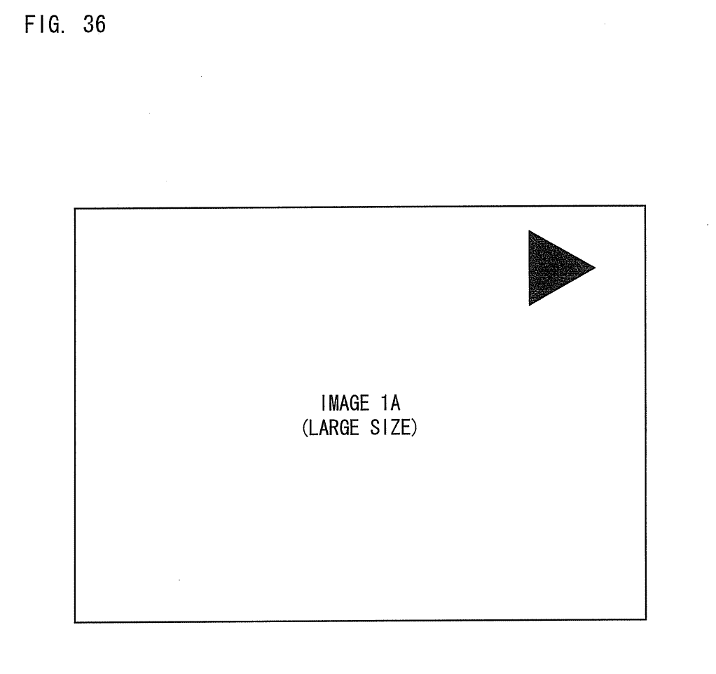

The following explains in detail a process of the large screen slide show execution thread, with reference to FIGS. 34 to 38. FIG. 34 is a flowchart of a large screen slide show execution thread. FIG. 35 is an explanatory diagram illustrating a specific example of content list information. FIGS. 36 to 38 are explanatory diagrams each illustrating an exemplary screen of a large screen slide show.

As shown in FIG. 34, first, the image display device 100C determines an image resource that is to be obtained from among image resources of an initial image by using a content information list (FIG. 35). Then, image data of the image resource is obtained and set as a display image (S2901). More specifically, the image display device 100C obtains, from the image server 410, a “JPEG_LRG” image of an image that is to be displayed next and put the “JPEG_LRG” image into a draw buffer.

Then, if the image that is to be displayed next is an initial image in a slide show (Yes in S2902), the image display device 100C transfers, to a video memory, the “JPEG_LRG” image that is put into the draw buffer and draws the “JPEG_LRG” image in a predetermined area of a screen (FIG. 36) (S2905).

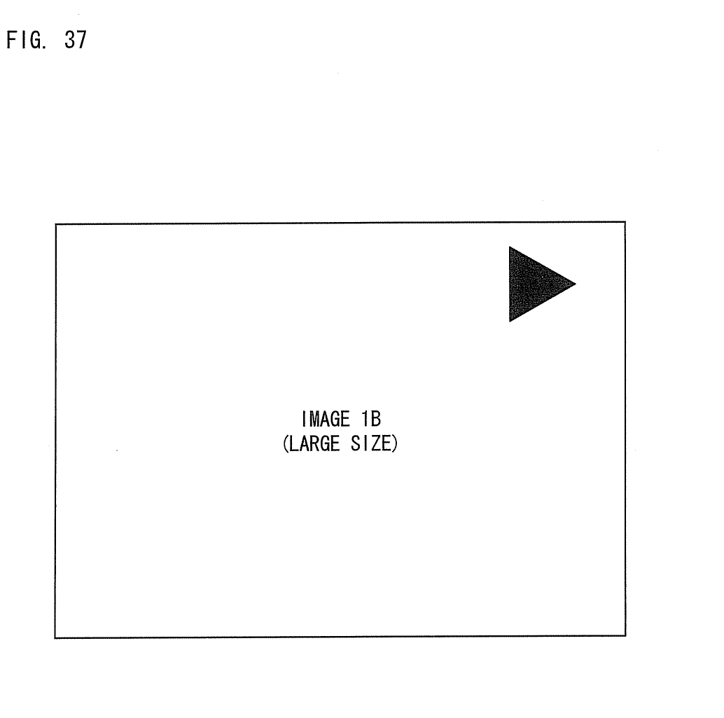

Then, the image display device 100C put another “JPEG_LRG” image that is to be displayed next into the draw buffer (S2901). If the another “JPEG_LRG” image that is to be displayed next is not the initial image in the slide show (No in S2901), the image display device 100C waits for elapse of a time of an image display interval in the slide show (S2903). Subsequently, in a mode (repeat reproduction mode) where images are displayed from the initial image after the last image in the folder is displayed, or in a case where an image that is being displayed is not the last image in the folder (Yes in S2904), the “JPEG_LRG” image put into the draw buffer is drawn in the predetermined area of the screen (FIG. 37) (S2905). Meanwhile, in a mode that is not the repeat reproduction mode or in a case where an image that is being displayed is the last image in the folder (No in S2904), the process of the large screen slide show execution thread is ended.

It may be arranged such that the repeat reproduction mode or none repeat reproduction mode can be set by a user operation with the use of a remote controller 250 or the like.

As described above, the image display device 100C repeats the steps S2901 to S2905 and continues the large screen slide show. Then, when display of all images are completed, the image display device 100C may return to display from the initial image and continue the slide show or the image display device 100C may once end the slide show as in the case of the preview slide show.

Here, the initial image may be an image that is listed first in the content information list. Alternatively, the initial image may be an image that is touched by a cursor when a decision key is pressed.

Next, the following explains a method of determining an image resource that is to be obtained for each image such as an initial image.

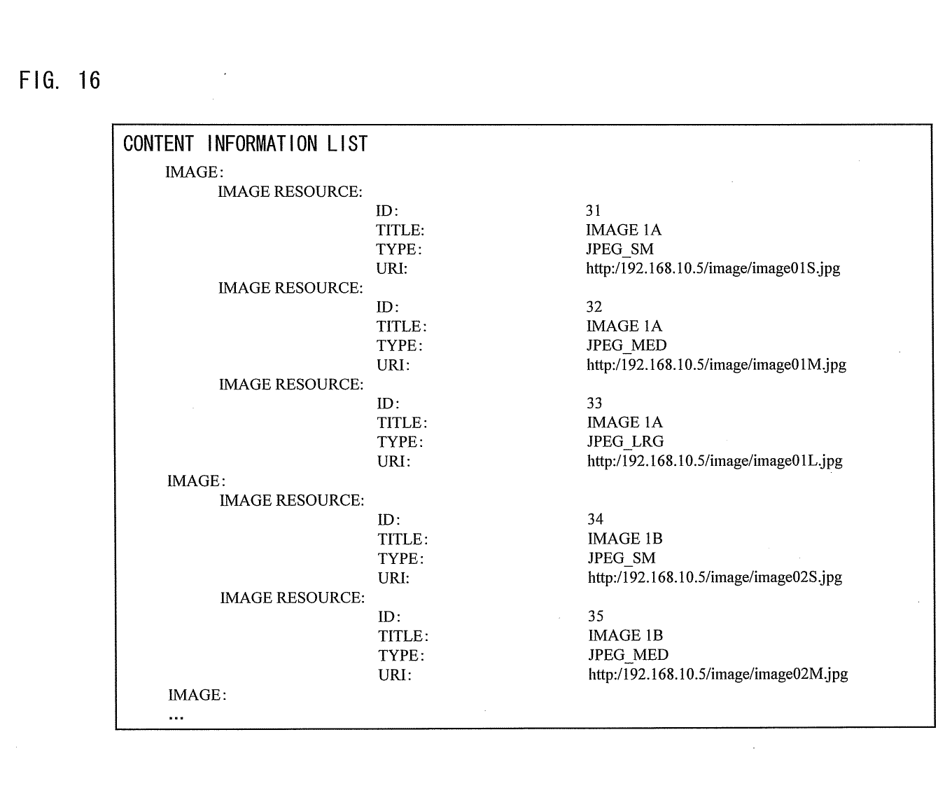

For display in a full screen of a display panel 205, it is desirable to obtain an image that is as large as possible. If a content information list that is provided by the image server 410 is a list shown in FIG. 16, an image having an image size that is the largest is obtained. In the present example, for an image 1A, a “JPEG_LRG” image data of an image resource having ID33 is obtained, and for an image 1B, a “JPEG_MED” image data of an image resource having ID35 is obtained. Note that, in a case where the content information list is like a list shown in FIG. 17, it may be arranged such that, with reference to a value indicated as an “image size”, an image resource whose size is the largest is used. Note that in the preview slide show display, “JPEG_SM” image data is used.

Further, as shown in FIG. 35, the image server 410 may present an “original image flag”. Such an original image flag is Yes (e.g. “1” in a case where a binary value is used) when the image resource is an original image that has not been subjected to a conversion process. On the other hand, such an original image flag is No (e.g. “0” in a case where a binary value is used) in a case where the image resource is an image that has been subjected to a conversion process. When such an original image flag is given, not an image type or an image size but the original image flag should be checked and an image whose original image flag is Yes should be obtained.

As shown in FIG. 36, the predetermined area in which the display image is drawn is, for example, the full screen (a whole screen capable of performing display). Here, as shown in FIG. 36, a graphic sign that is generally used for indicating that reproduction is being carried out may be displayed so as to overlap the image in a position (e.g. on a upper right corner of the screen) that is unlikely to cause inconvenience in browsing and viewing the image. This is for allowing it easy for a user to find that reproduction in a slide show is being carried out. An example of the graphic sign is a triangle facing right (an isosceles triangle having a vertex on the right).

Further, it is desirable to provide a function to make a pause during the slide show. In this case, when a user operation is made for giving an instruction to make a pause, a process for temporarily stopping transition to an image that is to be displayed is carried out in a state where the image display device 100C keeps displaying an image that is being displayed at the time when the operation is made. Note that it is desirable to continue reading a next image that is to follow the image being displayed then (S2901).

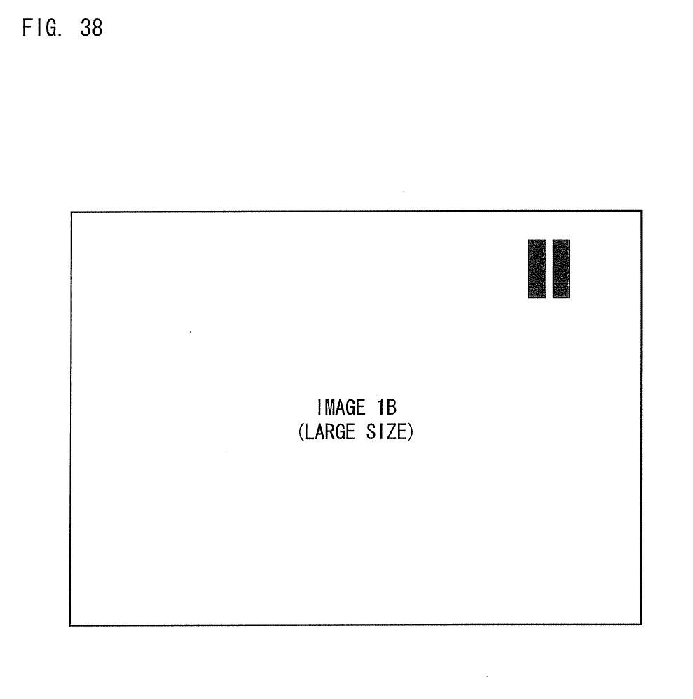

In the state of the pause, as shown in FIG. 38, a graphic sign that generally indicates a state of a pause may be displayed so as to overlap the screen. In this case, the graphic sign also should be displayed in a position that is unlikely to cause any inconvenience in browsing and viewing the image (e.g., on an upper right corner of the screen). An example of the graphic sign may be a figure made of two short vertical lines that are parallel to each other.

When a user subsequently makes an operation for giving an instruction to release the pause, the image display device 100C restart the large screen slide show. This operation for releasing the pause may be performed by an input by (a press of) the same key as a key for instructing the pause.

### Embodiment 4

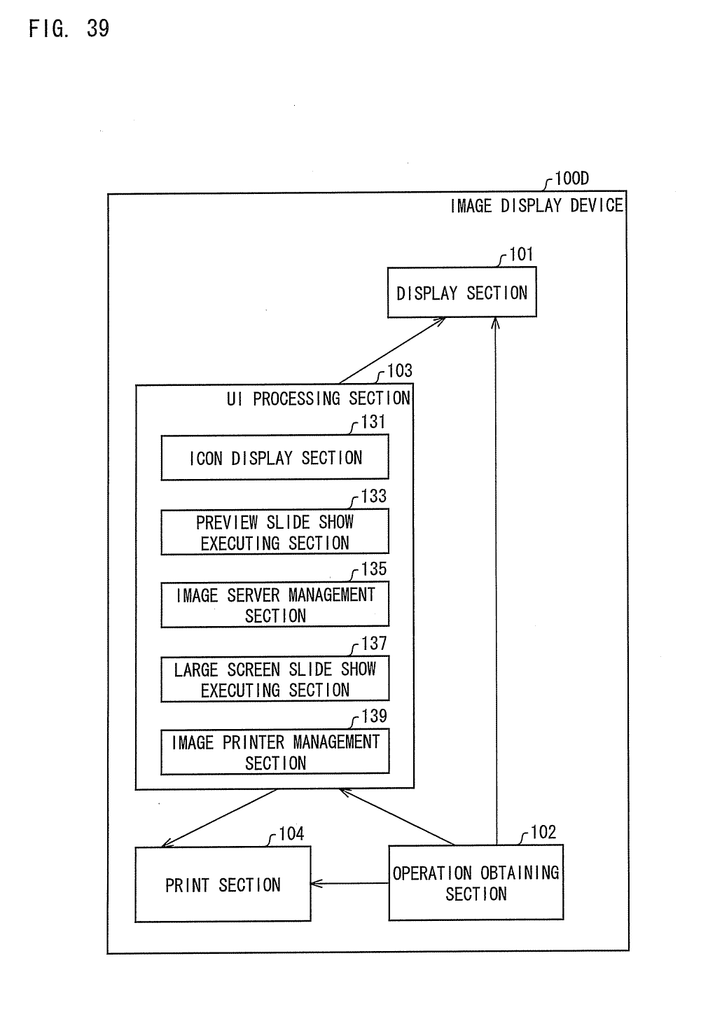

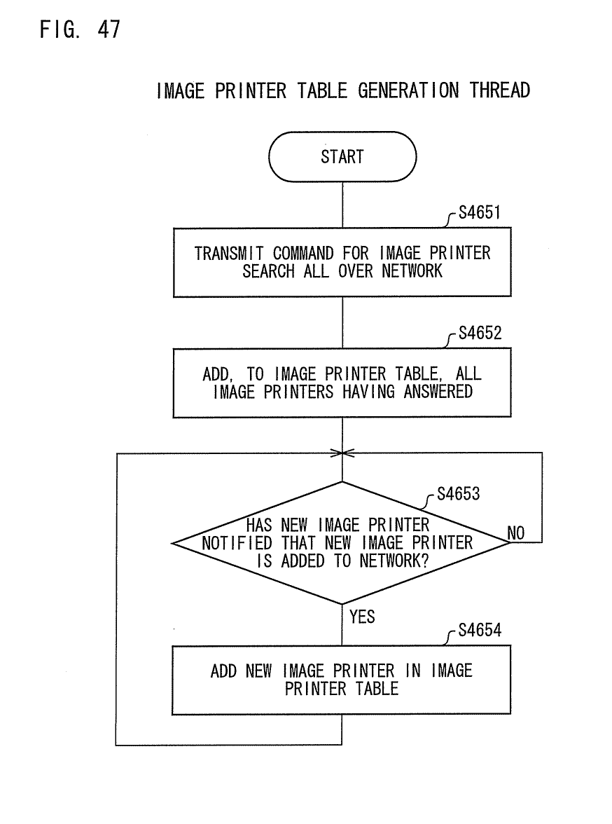

The following explains yet another embodiment of the present invention, with reference to FIGS. 39 to 48. Note that for convenience of explanation, members respectively having the same function as members in Embodiments 1 to 3 are denoted by the same reference signs, respectively, and explanations thereof are omitted. Further, regarding terms defined in Embodiments 1 to 3, the definitions of such terms are also applied to the present embodiment unless specifically noted otherwise.

The present embodiment adds, to Embodiment 3, a function to print an image. More specifically, in the present embodiment, while a large screen slide show is executed, an image that is being displayed in the large screen slide show can be printed by an image printer. Note that checking and browsing of image data on an image server 410 and the large screen slide show are the same as those in Embodiment 3, and explanations thereof are omitted.

FIG. 39 is a functional block diagram briefly illustrating a configuration of an image display device 100D of the present embodiment.

As shown in FIG. 39, a UI processing section 103 particularly includes an image printer management section (printer management means) 139, in addition an icon display section (icon display means) 131, a preview slide show executing section (preview slide show executing means) 133, an image server management section (server management means) 135, and a large screen slide show executing section (large screen slide show executing means) 137. Note that the icon display section 131, the preview slide show executing section 133, the image server management section 135 and the large screen slide show executing section 137 are the same as those in Embodiments 1 to 3, and therefore, explanations thereof are omitted.

The image printer management section 139 searches for devices (image printers a and b in FIG. 7) by which the image display device 100D can output a file and allows a user to select a device that is to be used. Note that the image printer management section 139 searches for image printers by an image printer table generation thread. The search for the image printers by the image printer table generation thread can be processed in the background. Further, the image printer management section 139 retains an image printer table that is generated by the image printer table generation thread.

Next, the following explains how functional blocks of the image display device 100D are related to hardware elements with reference to FIG. 39 and FIG. 9.

A CPU (central processing unit) 202 receives necessary information from a RAM (random access memory) 204 or a bus, according to a program, while sequentially reading out the program on a ROM (read only memory) 203, and then carries out drawing and display on a display panel 205 by using the necessary information; thereby the display section 101 is realized.

Further, the CPU 202 controls the operation input section 201 and receives necessary information via the RAM 204 or the bus, according to a program, while sequentially reading out the program on the ROM (read only memory) 203, and then stores data on the RAM 204 or transmits a message to another thread that is operating on the CPU 202, by using the necessary information; thereby the operation obtaining section 102 is realized.

The CPU 202 receives necessary information from the RAM 204 or the bus, according to a program, while sequentially reading out the program on the ROM 203, and then, by using the necessary information, carries out drawing and display on the display panel 205; thereby the UI processing section 103 is realized.

Here, folder and image data is in the image server 410 (FIG. 7) or the like that is connected to the network. The folder and image data is obtained via the network by a communication section 206. The data that is obtained via the network is processed by the display section 101 and the UI processing section 103 via a bus.

Further, the CPU 202 receives necessary information from the RAM 204 and/or the bus, according to a program, while sequentially reading out the program on the ROM 203, and in accordance with a result of a process using the necessary information, transmits the necessary information to an image printer 420 (FIG. 7) on the network via the network through the communication section 206; thereby, a printing section (printing means) 104 is realized.

Note that how each functional is related to the hardware elements explained here is merely one example and other implementation method is also possible.

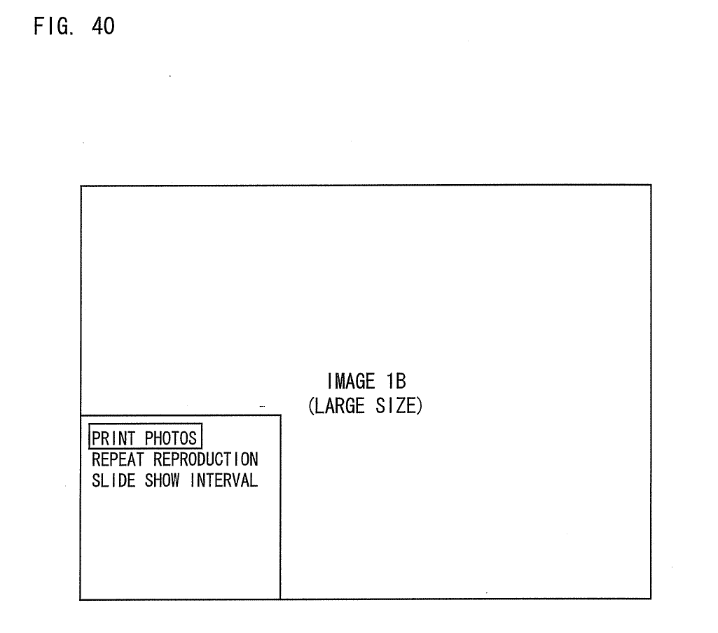

Next, the following explains a process at the time when printing is carried out by the image display device 100D, with reference to FIGS. 40 to 44. FIGS. 40 through 44 are explanatory diagrams illustrating exemplary display screens of the image display device 100D.

When a user makes an operation for displaying a menu during execution of the large screen slide show, the operation obtaining section 102 receives the operation and the menu is displayed on a screen via the display section 101 (FIG. 40). In the present example, “PRINT PHOTOS”, “REPEAT REPRODUCTION”, and “SLIDE SHOW INTERVAL” are displayed as menu items.

When “REPEAT REPRODUCTION” is selected in this menu screen, “repeat reproduction or non-repeat reproduction” can be set regarding reproduction in the large screen slide show. In a case of the repeat reproduction, the display returns to an initial image and reproduction is continued after the last image is reproduced. In a case of the non-repeat reproduction, a large screen slide show is once ended after the last image is reproduced in the large screen slide show.

Meanwhile, when “SLIDE SHOW INTERVAL” is selected, a screen display interval of the large screen slide show is set. This screen display interval can be set by displaying options such as “5 sec”, “10 sec”, “30 sec”, and “60 sec” in display of a sub-menu and selecting one from these options.

Note that the settings of the “REPEAT REPRODUCTION” and “SLIDE SHOW INTERVAL” above may also be applied to the preview slide show, or alternatively, such settings for the preview slide show may be separately set.

Further, when “PRINT PHOTOS” is selected, a process for printing photos is started. The following explains the process for printing photos.

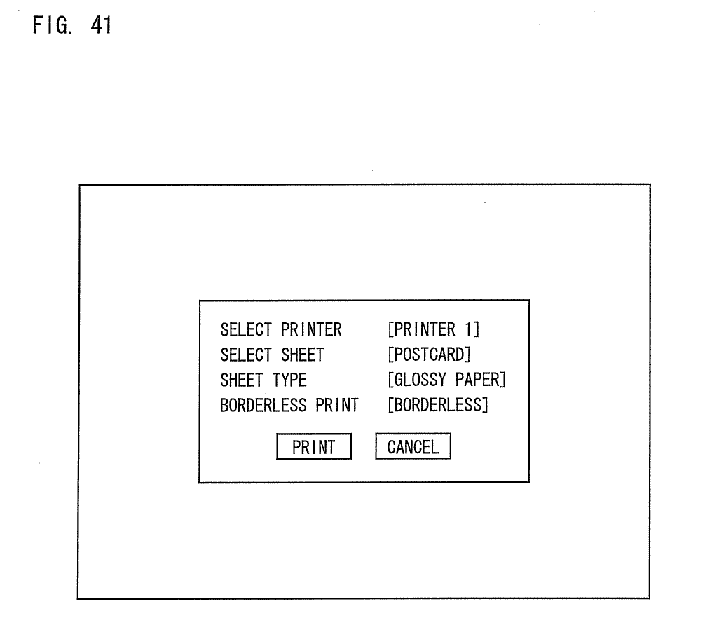

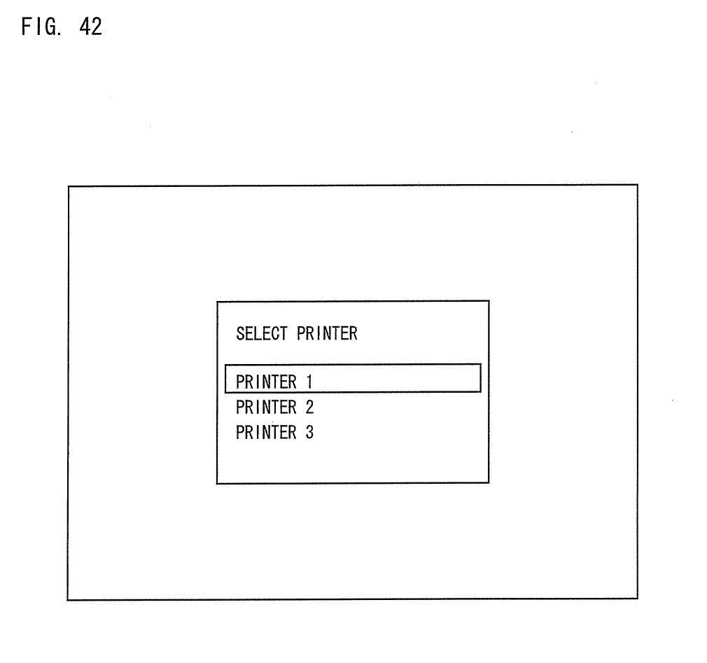

In the process for printing the photo, first, a setting screen as shown in FIG. 41 is displayed. When “SELECT PRINTER” is selected in the setting screen, a list of image printers connected to the network is displayed (FIG. 42). When a user selects an image printer from the list, thus selected image printer is set as a printer for use in printing.

In “SELECT SHEET”, a user selects a sheet by making a choice from among sheet sizes such as “L”, “postcard”, and “A4”. When a user selects a sheet size, thus selected sheet size is set as a sheet size that is to be used in printing.

In “SHEET TYPE”, a user selects a sheet type by making a choice from among sheet sizes such as “glossy paper” and “standard paper”. When a user selects a sheet type, thus selected sheet type is set as a sheet size that is to be used in printing.

In “BORDERLESS PRINT”, a user makes a choice from among “borderless” and “non-borderless”. When a user makes a choice, thus selected setting of the borderless print is applied in printing.

When “PRINT” is selected in the screen of FIG. 41, printing is carried out. Meanwhile, when “CANCEL” is selected, the image display device 100D returns to the screen of FIG. 40.

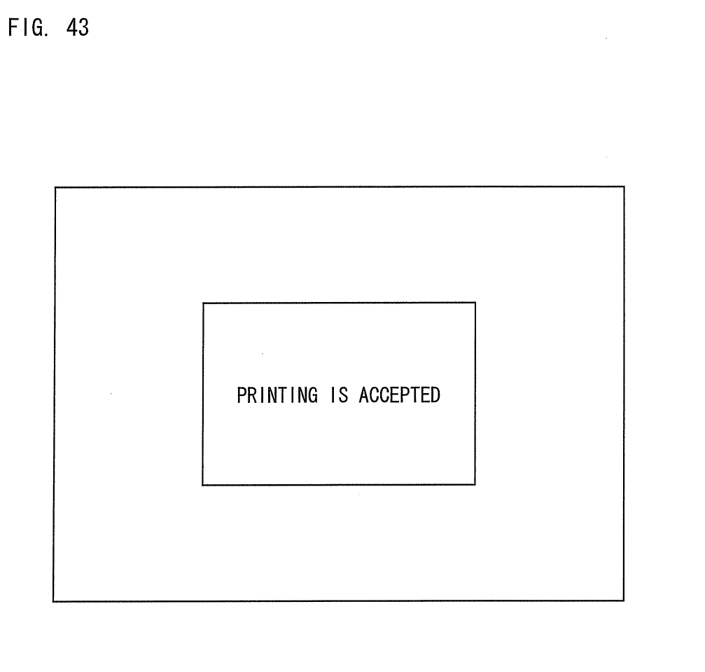

In a case where “PRINT” is selected in the screen of FIG. 41 and printing is to be carried out, the image display device 100D instructs the image printer 420 to print an image that is being displayed then. When the instruction is completed, the image display device 100D shows a dialogue that reads “Printing is accepted” (FIG. 43) for a predetermined period. Then, the image display device 100D returns to the large screen slide show.

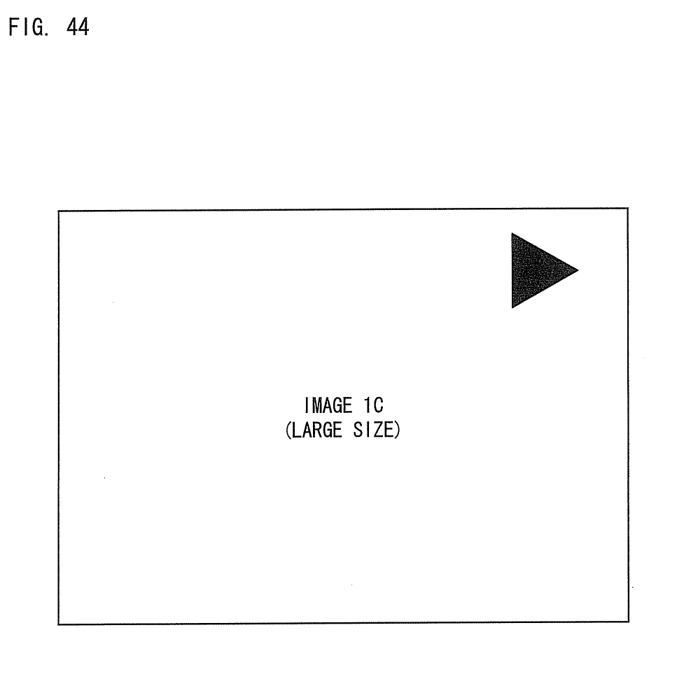

There is a case where the image display device 100B is in a state of pause when the menu of FIG. 40 is presented. In such a case, the image display device 100D returns to the state of pause when the image display device 100D returns to the large screen slide show. That is, the image display device 100D pauses, while keeping display of the image that is displayed then. On the other hand, in a case where the image display device 100D is not in the state of pause when the menu of FIG. 40 is presented, the image display device 100D re-continues execution of the slide show. That is, after display for a predetermined period, the image display device 100D transits to display of the next image (FIG. 44) and displays images sequentially.

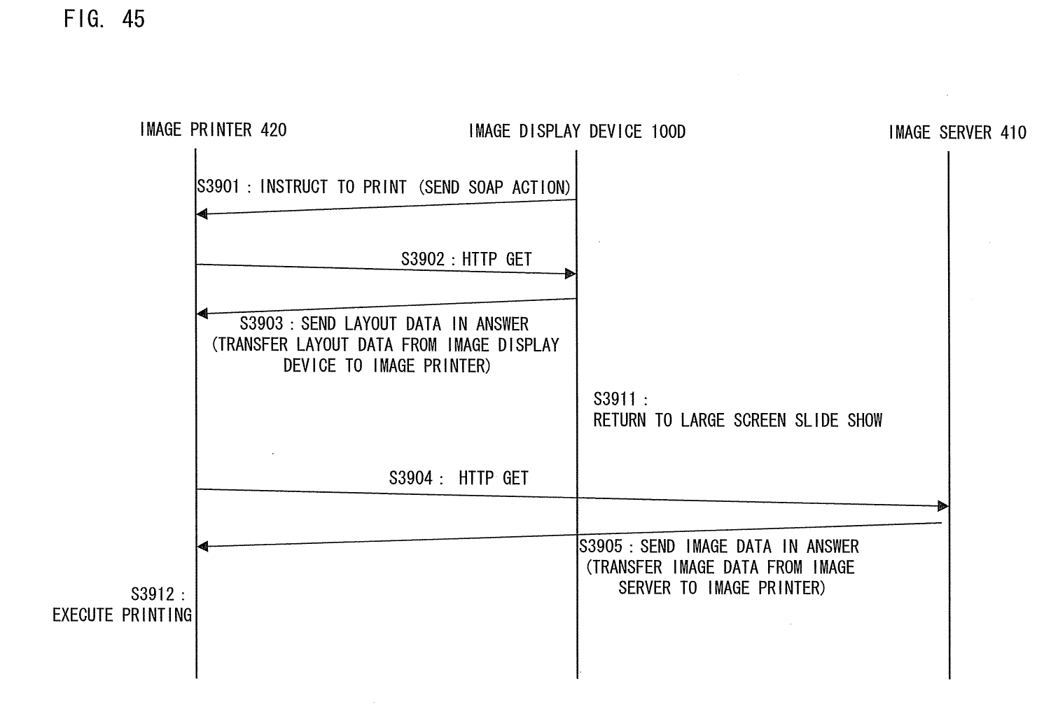

With reference to a sequence diagram of FIG. 45, the following briefly explains exchange of information and data between the image server 410 and the image printer 420 in printing by the image display device 100D.

When a user instructs to print, the image display device 100D instructs the image printer 420 to print (S3901). When making the instruction, the image display device 100D also transmits the setting information regarding the sheet, the sheet type and the borderless print as set above. Further, the image display device 100D generates layout information for printing and places the layout information in the image display device 100D, and then transmits a URI of a location of the layout information in the information relevant to the instruction.

Note that the setting information including the sheet, the sheet type, and the borderless print as set above can be contained in the layout information. Here, in the case of the borderless print, a whole space of a sheet is set as a print area. On the other hand, in the case of non-borderless print, the print area is set so that an appropriate margin is left at edges of a sheet space.

Further, the image display device 100D includes, as a URI, a location of image data that is to be used for printing in the layout information.

As the URI of the print image data, the URI indicated in the image resource of the content information list obtained from the image server 410 can be set. This location is a URI that indicates a location on the image server 410. Here, the image resource can be an image resource that has been determined at execution of the large screen slide show. However, the image resource may be another image resource of the same image. In display of the screen (large screen slide show), an image resource to be used has been decided depending on image display performance of the image display device 100D. However, in printing, an image resource to be used may be decided depending on print performance of the image printer 420.

The image printer to which the print instruction is directed is a printer set in the menu of FIG. 41.

When the image printer 420 receives the print instruction (S3901), the image printer 420 obtains, in accordance with information indicated in the print instruction, the layout information (that specifies a printed state) placed in the image display device 100D. This process is carried out by use of HTTP GET (S3902) and a response (S3903) to the HTTP GET. The layout information transmitted to the image printer 420 in the step S3903 includes a URI in the image server 410 which URI is associated with an image to be printed. That is, in this print process, no image data is transmitted from the image display device 100D to the image printer 420. Here, the URI of the image may be a relative URI to the image server 410. Alternatively, the URI of the image may be an absolute URI that include a URI of the mage server 410.

When the step S3903 is completed, the process relevant to the printing ends. Accordingly, the image display device 100D returns to the large screen slide show (S3911). More specifically, when the step S3903 is completed, the image display device 100D displays a dialog of FIG. 43. Then, after a predetermined period, the image display device 100D returns to the large screen slide show.

When the image printer 420 obtains the layout information, the image printer 420 obtains the print image data from the location indicated by the URI of the print image data in the layout information. This process is carried out by HTTP GET (S3904) and a response (S3905) to the HTTP GET.

After the printer 420 obtains the image data, the image printer 420 prints the image in accordance with the setting information (S3912).

Note that it is also possible to set a URI on the image display device 100D which URI is associated with a display image, instead of setting the URI indicating the location on the image server 410. In this case, the image printer 420 obtains the image data not from the image server 410 but from the image display device 100D.

The above sequence (FIG. 45) is only a brief illustration. Other than the above described exchange of information and data, information and data may be exchanged as appropriate.

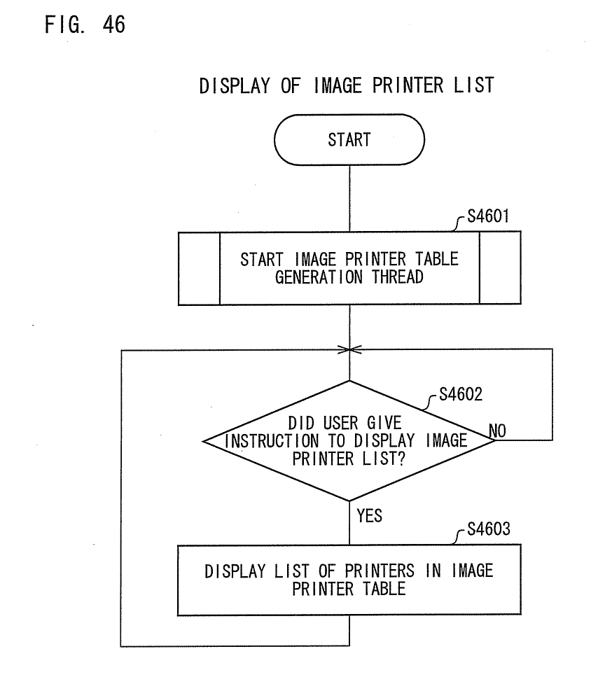

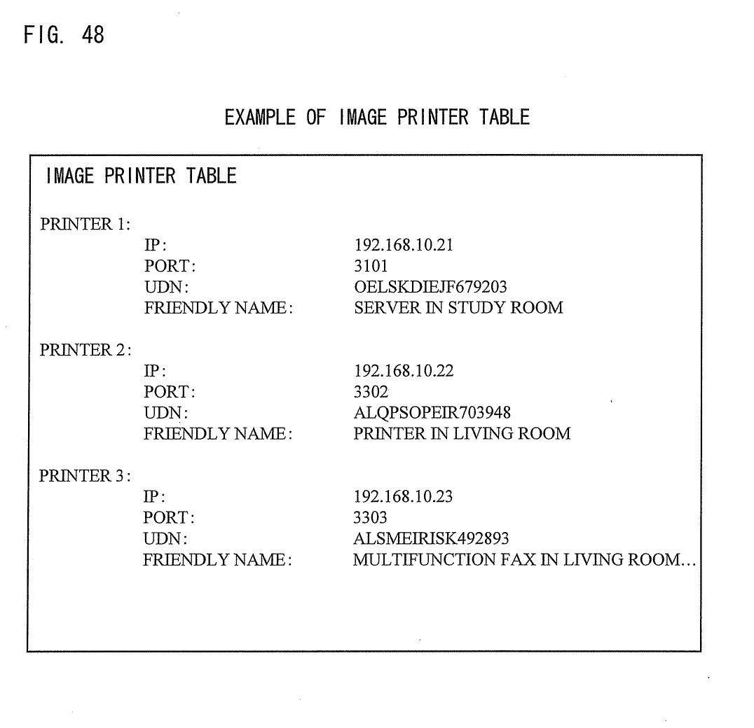

With reference to FIGS. 46 through 48, the following explains a process for displaying an image printer list by the image display device 100D. FIG. 46 is a flowchart of the process for displaying the image printer list. FIG. 49 is a flowchart of an image printer table generation thread. FIG. 48 is an explanatory diagram illustrating a specific example of an image printer table. Note that the specific example of the image printer list is as shown in FIG. 42.

As shown in FIG. 46, the image display device 100D starts an image printer table generation thread (S4601), for example, when the image display device 100D is started. Note that the image printer table generation thread started here can be thereafter continuously operated.

When the image display device 100D receives an instruction to display an image printer list from a user (Yes in S4602), the image display device 100D displays a list of image printers (FIG. 42) (S4603) in accordance with an image printer table (FIG. 48) that is generated by the image printer table generation thread.

Next, the following explains a process of the image printer table generation thread, with reference to FIG. 49.

First, the image display device 100D transmits a command for image printer search all over the network (S4651). Then, the image display device 100D adds, to the image printer table, all image printers that have responded (S4652). Subsequently, every time the image display device 100D receives a notification from an image printer that is newly connected to the network (Yes in S4653), the image display device 100D adds the image printer to the image printer table (S4654).

Here, as shown in FIG. 48, in the image printer table, an “IP”, a “port”, a “UDN”, and a “friendly name” of a printer found as a result of the image printer search are registered. Note that in the example of FIG. 29, a “server in a study room”, a “printer in a living room” and a “multifunction FAX in the living room” are registered as image printers.

Further, as shown in FIG. 42, a list of devices capable of providing images is displayed in the image printer list so that a user can make selection of an image printer. Then, the user selects a device by which the user prints an image, using this image printer list.

As described above, the image display device 100 (A, B, C, and D) according to an embodiment of the present invention displays a slide show (a preview slide show) of files in a folder corresponding to a folder icon that is selected from folder icons that are displayed in a list in an icon display area. The slide show (preview slide show) of these files is displayed in a preview display area that is in the same screen as the icon display area. Further, an operation of the image display device 100 varies between a case where a file icon is selected and a case where a folder icon is selected. That is, when a cursor hits a folder, a slide show of images in the folder is performed in the preview display area 302 other than the icon display area 303 (FIG. 5). On the other hand, in a case where the cursor hits an image, the image is displayed in the preview display area. Furthermore, in a case where an image file is in an image server on a network, the image display device 100 uses an image having a resolution of a predetermined condition among images provided by the image server.

Further, when a folder icon in a list that is displayed in the icon display area is selected and the selection of the folder icon is decided, the image display device 100 displays, in the icon display area, a list of files and folders which are stored in the folder icon.

Further, when a file icon in a list displayed in the icon display area together with folder icons is selected and further the selection of the file icon is decided, the image display device 100 displays, on a screen different from the icon display area, a slide show (a large screen slide show) of files in a folder containing a file corresponding to the file icon.

The above embodiments by no means limits the scope of the present invention but may be varied in many ways within the scope of the present invention. For example, the following configuration is possible.

An image display device of the present invention may be configured to include: display means for displaying an object specifying element corresponding to an image folder; operation input means for detecting an operation for selecting the object specifying element corresponding to the image folder; and slide show executing means for sequentially and automatically displaying, on the display means, images in the image folder corresponding to the object element selected via the operation input means, the slide show executing means sequentially and automatically displaying, on the display means, the images in an area different from an area where the object specifying element corresponding to the image folder is displayed.

Here, the “object specifying element” is associated with an operation target object to be subjected to an operation, and intended for allowing a user of the image display device to make an operation on the operation target object associated with the “object specifying element” which operation is made by selecting the “object specifying element” on the display means with the use of a screen cursor or the like. For example, the “object specifying element” includes an icon indicating an operation target object in the form of a simple picture, or also may simply be a descriptive text representation of a name of the operation target object (an image folder name in the case of an image folder).

Further, the image display device may be configured such that: the display means displays an object specifying element corresponding to an image; the operation input means detects an operation for selecting the object specifying element corresponding to the image; and the slide show executing means displays, on the display means, the image corresponding to the object specifying element, when the object specifying element corresponding to the image is selected via the operation input means.

Furthermore, regarding the image display device, the image and the image may be placed on an image server connected via a network.

In such a configuration, images in various devices can be used as an object for checking and browsing, while no additional troublesome operation such as copying is required. Further, images in many devices all around a house or on the network can be quickly checked and browsed while a user stays at one position.

Further, the image display device may be configured such that the slide show executing means obtains a list of images having a plurality of resolutions corresponding to one image content from the image server, and obtains an image so as to use the image in a slide show which image satisfies a predetermined condition.

Further, the image display device may be configured such that the predetermined condition is a resolution of the image within a predetermined resolution.

In the above configuration, it is possible to obtain an image of a necessary and sufficient resolution. As a result, as compared to a case where an original image is always obtained, it is possible to reduce a time taken for image communication and therefore to allow a user to check and display an image more quickly. It also becomes possible to save a communication frequency band in the network.

Further, the image display device may be configured such that the slide show executing means obtains image attribute data of the image from the image server and displays the image attribute data on the display means.

In such a case, a user can check whether or not an image being displayed is an intended image, based on the attribute data displayed. This makes it possible to more quickly check and display an image.
Further, the image display device may be configured such that the slide show executing means obtains, from the image server, an image that is to be displayed next and store this image temporarily, while another image is displayed.

In such a configuration, it is possible to reduce a necessary time by a time required for obtaining, from the image server, an image that is to be displayed next. This allows a user to more quickly check and display an image. It also becomes possible to save a communication frequency band of the network.

Each block of the image display device 100, in particular, the UI processing section 103 may be constituted by hardware logic or may be realized by software by using a CPU.

In such a configuration, the image display device 100 includes a CPU (central processing unit) that executes the order of a control program for realizing functions, a ROM (read only memory) that stores the control program, a RAM (random access memory) that develops the control program in an executable form, and a storage device (storage medium), such as memory, that stores the control program and various types of data therein. The object of the present invention can be achieved by a predetermined storage medium. The storage medium stores, in a computer-readable manner, program codes (executable code program, intermediate code program, and source program) of the control program of the image display device 100 of the present invention, which is software for realizing the aforesaid functions. The storage medium is provided to the image display device 100. With this arrangement, the image display device 100 (alternatively, CPU or MPU) as a computer reads out and executes the program code stored in the storage medium provided.

The storage medium may be: tape based, such as a magnetic tape or cassette tape; disc based, such as a magnetic disk including a Floppy® disc and hard disk, and optical disk including CD-ROM, MO, MD, DVD, and CD-R; card based, such as an IC card (including a memory card) and an optical card; or a semiconductor memory, such as a mask ROM, an EPROM, an EEPROM, and a flash ROM.

Further, the image display device 100 of the present invention may be arranged so as to be connectable to a communications network so that the program code is supplied to the image display device 100 through the communications network. The communications network is not to be particularly limited. Examples of the communications network include the Internet, intranet, extranet, LAN, ISDN, VAN, CATV communications network, virtual private network, telephone network, mobile communications network, and satellite communications network. Further, a transmission medium that constitutes the communications network is not particularly limited. Examples of the transmission medium include (i) wired lines such as an IEEE 1394 cable, a USB cable, a power-line carrier, cable TV lines, telephone lines, and ADSL lines and (ii) wireless connections such as IrDA using infrared light, Bluetooth®, 802.11, HDR, mobile phone network, satellite connections, and terrestrial digital network. Note that the present invention can be also realized by the program codes in the form of a computer data signal embedded in a carrier wave which is embodied by electronic transmission.

As described above, an information processing device of the present invention includes: icon display means displaying a list of folder icons indicative of the folders, in an icon display area; and preview slide show executing means displaying a slide show of files stored in a folder, in a preview display area in a screen where the icon display area is present, the folder corresponding to a folder icon selected from among the folder icons displayed by the icon display means in the list in the icon display area.

An information processing method of the present invention includes the steps of: displaying a list of folder icons indicative of the folders, in an icon display area; and displaying a slide show of files stored in a folder, in a preview display area within a screen where the icon display area is present, the folder corresponding to a folder icon selected from among the folder icons displayed by the icon display means in the list in the icon display area.

Therefore, it becomes possible to display a preview of a plurality of files in a folder, at an image size larger than that of a folder icon and at a resolution higher than that of the folder icon. This allows a user to easily make an operation on a folder icon list display, concurrently with checking each file by using a preview image in which each file is easily viewed.

Further, the information processing device of the present invention is configured such that: when selection of a folder icon is made and further the selection is decided, the icon display means displays, in the icon display area, a list of files and folders stored in the folder icon, the folder icon being displayed in the list in the icon display area.

In the above configuration, when selection of a folder icon is decided, a list of files and folders stored in the folder icon are displayed in the icon display area. That is, by opening the folder, a list of the files and the folders inside the folder can be displayed in the icon display area.

Further, the information processing device of the present invention, further includes: large screen slide show executing means, wherein: the icon display means displaying, in the icon display area, file icons indicative of files as well as the folder icons; and the large screen slide show executing means displays a slide show of files in another screen different from the screen of the icon display area, when selection of a file icon displayed by the icon display means in the list in the icon display area is made and further this selection is decided, the files being stored in a folder containing a file corresponding to the file icon.

In the above configuration, when selection of a file icon is decided, a slide show of files stored in a folder including a file corresponding to the folder icon is displayed in a screen that is different from a screen of the icon display area. Therefore, from the screen where a list of the file icons are displayed, display can be easily switched to the slide show.

Note that the above information processing device may be realized by a computer. In such a case, the scope of the present invention encompasses a control program (information processing program) of the information processing device which control program causes the computer to function as each means described above for realizing the information processing device by the computer, and a computer-readable storage medium storing such a control program.

The present invention is not limited to the description of the embodiments above, but may be altered by a skilled person within the scope of the claims. An embodiment based on a proper combination of technical means disclosed in different embodiments is encompassed in the technical scope of the present invention.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

According to the present invention, a preview of files of images or the like stored in a folder can be displayed at a sufficient image size and at a sufficient resolution in a screen in which a list of folder icons and file icons (image thumbnails or the like) are displayed. Accordingly, a user can easily carry out an operation for browsing of files or the like. Therefore, the present invention can be widely applied to an information processing device handling a large number of files, in particular, a large number of image files.

### REFERENCE SIGNS LIST

100 (100A, 100B, 100C, 100D) Image Display Device (Information Processing Device)
131 Icon Display Section (Icon Display Means)
133 Preview Slide Show Executing Section (Preview Slide Show Executing Means)
137 Large Screen Slide Show Executing Section (Large Screen Slide Show Executing Means)
302 Preview Display Area
303 Icon Display Area

1. An information processing device managing files stored in folders, the information processing device comprising:
icon display section displaying a list of folder icons indicative of the folders and thumbnail images of image files, in an icon display area; and
preview slide show executing section displaying a slide show of images of files stored in a folder, in a preview display area in a screen where the icon display area is present, the images having a size larger than a size of the thumbnail images, the folder corresponding to a folder icon on which a cursor for selecting a folder icon or an thumbnail image is placed, the folder icon being among the folder icons displayed in the list in the icon display area by the icon display section.

2. The information processing device as set forth in claim 1, wherein:
when the cursor is placed on a folder icon and further the folder icon is selected by the cursor, the icon display section displays, in the icon display area, a list of files and folders stored in a folder corresponding to the folder icon, the folder icon being displayed in the list in the icon display area.

3. The information processing device as set forth in claim 1, wherein:
the preview slide show executing section displays, in the preview display area, a file corresponding to a thumbnail image on which the cursor is placed, when the cursor is placed on the thumbnail image being displayed in the icon display area by the icon display section.

4. The information processing device as set forth in claim 3, wherein:
the preview slide show executing section displays, in the preview display area, files corresponding to the folder icon on which the cursor is placed, when a predetermined regular period elapses after the cursor has been moved.

5. The information processing device as set forth in claim 1, further comprising:
large screen slide show executing section displaying a slide show of files in another screen different from the screen of the icon display area, when the cursor is placed on a thumbnail image displayed by the icon display section in the list in the icon display area and further the thumbnail image is selected by the cursor, the files being stored in a folder containing a file corresponding to the thumbnail image.

6. The information processing device as set forth in claim 5, further comprising:
a communication section for communicating with another device connected to a network; and
a print section for causing a printer connected to the network to print a file for which a print instruction is given, when the print instruction in connection to the file is accepted, the file being displayed by the large screen slide show executing section.

7. The information processing device as set forth in claim 6, further comprising:
printer management section searching for available printers that the printer section is capable of causing to print the file, the printer management section allowing a user to select a printer to be used in printing among from the available printers.

8. The information processing device as set forth in claim 1, further comprising:
a communication section for communicating with another device connected to a network,
the icon display section displaying, in the icon display area, folder icons respectively corresponding to folders in a server connected to the network,
the preview slide show executing section (i) obtaining, via the communication section, a list in which files are respectively associated with storage locations of the files, when the cursor is placed on a folder icon corresponding to a folder in the server, the list corresponding to the folder icon on which the cursor is placed, the list being obtained from the server, and (ii) then obtaining a file to be displayed in the preview display area from a storage location of the file by use of the list obtained.

9. The information processing device as set forth in claim 8, further comprising:
server management section searching, from among servers connected to the network, for available servers capable of providing the folder icon, the server management section allowing a user to select a server to be used from among the available servers.

10. The information processing device as set forth in claim 8, wherein:
the preview slide show executing section does not newly obtain another list but repeats display of a slide show of the files in the list, unless an operation for giving an instruction to stop the slide show is obtained.

11. The information processing device as set forth in claim 8, wherein:
in a case where one file is associated with a plurality of resources in the list, the preview slide show executing section determines a resource to be obtained, on the basis of one or both of (i) whether or not the resource is a resource of an original file that has not been subjected to a conversion process and (ii) a file size of a file of the resource.

12. An information processing method of an information processing device managing files stored in folders, the method comprising the steps of:
displaying a list of folder icons indicative of the folders and thumbnail images of image files, in an icon display area; and
displaying a slide show of images of files stored in a folder, in a preview display area within a screen where the icon display area is present, the images having a size larger than a size of the thumbnail images, the folder corresponding to a folder icon on which a cursor for selecting a folder icon or an thumbnail image is placed, the folder icon being among the folder icons displayed in the list in the icon display area by the icon display section.

13. A non-transitory storage medium storing an information processing program for causing a computer to carry out the steps of:
displaying a list of folder icons indicative of the folders and thumbnail images of image files, in an icon display area; and
displaying a slide show of images of files stored in a folder, in a preview display area within a screen where the icon display area is present, the images having a size larger than a size of the thumbnail images, the folder corresponding to a folder icon on which a cursor for selecting a folder icon or an thumbnail image is placed, the folder icon being among the folder icons displayed in the list in the icon display area by the icon display section.

14. (canceled)

15. The information processing device as set forth in claim 1, further comprising:
a communication section for communicating with another device connected to a network,
the preview slide show executing section displaying, in the preview display area, a slide show of images of image files stored in a folder corresponding to a folder icon on which the cursor is placed, the images having a file size that is larger than a file size of the thumbnail images but smaller than a file size of original image files,
the icon display section displaying, in the icon display area, folder icons respectively corresponding to folders in a server connected to the network,
the preview slide show executing section (i) obtaining, via the communication section, a list in which files are respectively associated with storage locations of the files, when the cursor is placed on the folder icon corresponding to the folder in the server, the list corresponding to the folder icon and being obtained from the server, and (ii) then obtaining an image to be displayed in the preview display area from a storage location of the file by use of the list obtained, the image having a file size that is larger than the file size of the thumbnail images but smaller than the file size of original image files.
